(19) United States
(12) Patent Application Publication
(10) Pub. No.: US 2026/0000573 A1
(43) Pub. Date: Jan. 1, 2026

(54) APPARATUS FOR TREATING MYOFASCIAL POINTS

(71) Applicant: Gasner Healthtech Inc., Toronto (CA)

(72) Inventor: John Joseph GASNER, Toronto (CA)

(73) Assignee: Gasner Healthtech Inc., Toronto (CA)

(21) Appl. No.: 19/320,697

(22) Filed: Sep. 5, 2025

Related U.S. Application Data
(63) Continuation-in-part of application No. 18/061,600, filed on Dec. 5, 2022.
(60) Provisional application No. 63/286,784, filed on Dec. 7, 2021.

(51) Int. Cl. A61H 23/00; A61H 23/02

(52) U.S. Cl. CPC A61H 23/004; A61H 23/02; A61H 2201/0153; A61H 2205/026

(57) ABSTRACT

A myofascial release apparatus (MRA) for relieving at least one hyperirritable area via the vibrational energy in one of interior to an oral cavity and exterior to the oral cavity. MRA may include a handle and a motor that is operably engaged with the handle and is configured to generate a mechanical energy. MRA may also include a drive assembly that is operably engaged with the motor and the handle and is configured to generate a vibrational energy. MRA may also include an electrical control assembly that is electrically connected with the motor for controlling said motor. MRA may also include at least one head component operably connected with the handle and the drive assembly. The at least one head component is removable from the handle and the motor and is configured to relieve at least one hyperirritable area via the vibrational energy.

### REFERENCE TO RELATED APPLICATIONS

This application is a continuation-in-part of U.S. application Ser. No. 18/061,600, filed on Dec. 5, 2022, which claims the benefit of U.S. Provisional Application Ser. No. 63/286,784, filed on Dec. 7, 2021; the disclosures of which are incorporated herein by reference.

### TECHNICAL FIELD

This disclosure is directed to a therapeutic treatment device for treating temporomandibular jaw (or TMJ) disorder both intraorally and extraorally.

### BACKGROUND OF THE INVENTION

Temporomandibular jaw (or TMJ), or the jaw joint, acts as a sliding hinge mechanism that connects a person's mandible, or jaw bone, to the person's skull. Each person has a TMJ on each side of their jaw bone for opening and closing his or her mouth. However, a person may develop disorders or conditions (such as temporomandibular disorder or TMD) that may lead to pain in one or both TMJs or muscle groups that control the opening and closing movements of the jaw bone. The exact cause of a person's TMJ disorder is difficult to determine since TMJ disorder may be brought on by various factors such as genetics, arthritis, or jaw injuries (e.g., clench or grinding of teeth known as bruxism). Such jaw injuries may be caused by acute traumatic issues or chronic damaging breakdown that results in the deterioration of the TMJ joint (i.e., the articular disc) or muscles supporting the TMJ joint.

While most pain and discomfort associated with TMJ disorders is temporary, self-managed care or nonsurgical treatments are used to combat such pain and discomfort. However, medication care and treatments may only provide temporary relief and/or may not provide enough relief to combat the pain and discomfort. In these instances, a patient's doctor or dentist may need to prescribe even stronger medication for a limited time. Moreover, oral splints or mouth guards (i.e., occlusal appliances) used to combat TMJ disorders are rather cumbersome for a patient to wear and are not well-understood as to treating TMJ disorders. Furthermore, physical therapy and counseling treatments may provide treatment for TMJ disorder but such treatments may result in only temporary relief and inconveniences for the patient for an extended period of time.

In extreme conditions, surgical operation or other procedures may be used to relief and solve TMJ disorders. However, such surgical operations and procedures have limitations in providing specific repairs and may result in unexpected risks and costs to the patient.

### SUMMARY

The presently disclosed myofascial release apparatus provides a user with a device for treating TMD intraorally and extraorally at desired trigger points or hyperirritable areas on the patient, specifically at or near the patient's TMJ. The disclosed myofascial release apparatus may also provide instant relief to the TMJ along with accurate intraoral trigger point release or hyperirritable area release to the patient's lateral and medial pterygoids. The disclosed myofascial release apparatus may also provide instant relief to extraoral trigger points or muscles connected with the patient's TMJ such as the masseter muscle, temporalis muscle, sternocleidomastoideole, and the trapezius muscle. The disclosed myofascial release apparatus disclosed herein addresses some of the inadequacies of previously known devices and methods of treating TMD.

In one aspect, an exemplary embodiment of the present disclosure may provide a myofascial release apparatus (MRA). MRA may include a handle and a motor operably engaged with the handle and configured to generate a mechanical energy. MRA may also include a drive assembly operably engaged with the motor and the handle and configured to generate a vibrational energy. MRA may also include an electrical control assembly electrically connected with the motor for controlling said motor. MRA may also include at least one head component operably connected with the handle and the drive assembly. The at least one head component is removable from the handle and the motor, and the at least one head component is configured to relieve at least one hyperirritable area via the vibrational energy.

This exemplary embodiment or another exemplary embodiment may further include that the at least one head component is configured to relieve the at least one hyperirritable area via the vibrational energy in one of interior to an oral cavity and exterior to the oral cavity. This exemplary embodiment or another exemplary embodiment may further include that the electrical control assembly comprises: a primary controller operably engaged with the motor and configured to enable the motor to generate the mechanical energy; and a head sensor switch electrically connected with the primary controller and configured to engage with the at least one head component; wherein when the head sensor switch engages with the at least one head component, the head sensor switch is configured to send at least one electrical signal to the primary controller to enable the motor to generate the mechanical energy at at least one rotational speed. This exemplary embodiment or another exemplary embodiment may further include that the electrical control assembly further comprises: a secondary controller operably engaged with the handle and electrically connected with the primary controller; wherein the secondary controller is configured to send at least another electrical signal to the primary controller to toggle a power state of the motor between an ON state and an OFF state. This exemplary embodiment or another exemplary embodiment may further include that the electrical control assembly further comprises: a toggle switch operably engaged with the handle and electrically connected with the secondary controller; wherein the toggle switch is configured to enable the secondary controller to send the at least another electrical signal to the primary controller to toggle a power state of the motor between an ON state and an OFF state. This exemplary embodiment or another exemplary embodiment may further at least another head component operably connected with the handle and the drive assembly; wherein when the head sensor switch engages with the at least another head component, the head sensor switch is configured to send at least another electrical signal to the primary controller to enable the motor to generate the mechanical energy at at least another rotational speed that is different than the at least one rotational speed. This exemplary embodiment or another exemplary embodiment may further a vibration transfer element operably engaged with the handle and the drive vibration assembly; wherein the vibration transfer element is configured to transfer the vibrational energy from the drive assembly to the at least one head component. This exemplary embodiment or another exemplary embodiment may further include that the drive assembly comprises: at least one spring operably engaged with the motor; and a vibration weight operably engaged with the vibration transfer element and the at least one spring for generating the vibrational energy. This exemplary embodiment or another exemplary embodiment may further include that the drive assembly further comprises: an upper roller bearing operably engaged with the vibration weight and the vibration transfer element; and a lower roller bearing operably engaged with the vibration weight and the vibration transfer element. This exemplary embodiment or another exemplary embodiment may further include that the handle further comprises: an upper support extending from a top end of the handle towards a bottom end of the handle opposite to the top end; a lower support extending from the bottom end of the handle towards the top end of the handle; and an intermediate cavity defined between the upper support and the lower support. This exemplary embodiment or another exemplary embodiment may further include that the drive assembly further comprises: at least another spring operably engaging the upper support and the lower support with one another and encapsulating the at least one spring; wherein the at least another spring configured to transfer the vibrational energy from the lower support to the upper support. This exemplary embodiment or another exemplary embodiment may further include that the at least one head component further comprises: a base member provided at a first end of the at least one head component; a support member operably engaged with the base member and extending between the first end of the at least one head component to a second end of the head component opposite to the first end of the at least one head component; and a contact member operably engaged with the support member at the second end of the at least one head component, wherein the contact member is configured to relieve the at least one hyperirritable area interior to an oral cavity and exterior to the oral cavity. This exemplary embodiment or another exemplary embodiment may further include that the handle further comprises at least one engagement member positioned at a first end of the handle, wherein the at least one engagement member is configured to interlockingly engage with the base member of the at least one head component. This exemplary embodiment or another exemplary embodiment may further include that the at least one head component further comprises: a cavity defined in the at least one head component, wherein the cavity is configured to enable the drive assembly to be operably engaged with the at least one head component. This exemplary embodiment or another exemplary embodiment may further include that the at least one head component further comprises: a first diameter defined at the first end of the support member proximate to the base member; and a second diameter defined at the second end of the support member proximate to the contact member; wherein the second diameter is less than the first diameter such that the support member tapers inwardly from the first end to the second end. This exemplary embodiment or another exemplary embodiment may further include that the support member of the at least one head component and the contact member of the at least one head component are directly aligned with one another or offset from one another. This exemplary embodiment or another exemplary embodiment may further include that the at least one head component further comprises: a bend formed in the support member between the base member and the contact member; wherein the base member and the contact member are offset from one another. This exemplary embodiment or another exemplary embodiment may further include that that contact member of the at least one head component is generally spheroid-shaped. This exemplary embodiment or another exemplary embodiment may further include that the contact member of the at least one head component is generally trapezoidal-shaped.

In yet another aspect, an exemplary embodiment of the present disclosure may provide a myofascial release apparatus (MRA). MRA may include a handle and a motor operably engaged with the handle and configured to generate a mechanical energy. MRA may also include a drive assembly operably engaged with the motor and the handle and configured to generate a vibrational energy. MRA may also include an electrical control assembly electrically connected with the motor for controlling said motor. MRA may also include at least one head component operably connected with the handle and the drive assembly; wherein the at least one head component is removable from the handle and the motor, and wherein the at least one head component is configured to relieve at least one hyperirritable area via the vibrational energy in one of interior to an oral cavity and exterior to the oral cavity.

In yet another aspect, an exemplary embodiment of the present disclosure may provide a method of relieving a hyperirritable area on or surrounding a mandible. Method may comprise steps of: selecting a first head component from a set of head components of a myofascial release apparatus (MRA); connecting the first head component with a handle of the MRA; locating the hyperirritable area on or surrounding the mandible of a patient experiencing muscle tension; contacting the hyperirritable area, via a contact member of the first head component, on or surrounding the mandible of the patient; actuating a motor of the MRA, via an electrical control assembly of the MRA, from an OFF state to an ON state for vibrating the first head component at at least one predetermined frequency; and relieving the hyperirritable area on or surrounding the mandible.

This exemplary embodiment or another exemplary embodiment may further include that the step of relieving the hyperirritable area on or surrounding the mandible further includes that the hyperirritable area is a myofascial trigger point that is one of interior to an oral cavity of the patient and exterior to the oral cavity of the patient. This exemplary embodiment or another exemplary embodiment may further include steps of actuating a head sensor switch of the electrical control assembly; sending at least one electrical signal to a primary controller of the electrical control assembly; and controlling the motor, via the primary controller, for vibrating the at least one head component at the at least one predetermined frequency. This exemplary embodiment or another exemplary embodiment may further include steps of introducing the first head component into an oral cavity of the patient; and contacting an intraoral muscle, via the contact member, positioned inside of the oral cavity of the patient. This exemplary embodiment or another exemplary embodiment may further include that the step of contacting the intraoral muscle positioned inside of the oral cavity of the patient includes the intraoral muscle being a lateral pterygoid muscle. This exemplary embodiment or another exemplary embodiment may further include that the step of contacting the intraoral muscle positioned inside of the oral cavity of the patient includes the intraoral muscle being a medial pterygoid muscle. This exemplary embodiment or another exemplary embodiment may further include that the step of contacting the intraoral muscle positioned inside of the oral cavity of the patient includes the intraoral muscle being proximate to a maxillary tuberosity. This exemplary embodiment or another exemplary embodiment may further include steps of removing the first head component from the handle; selecting a second head component from the set of head components; connecting the second head component with the handle; actuating the motor, via the switch, from the OFF state to the ON state to vibrate the second head component at the predetermined frequency; locating a second hyperirritable area on or surrounding the patient experiencing muscle tension; contacting the second hyperirritable area, via a second contact member of the second head component, on or surrounding the mandible of the patient; and relieving the second hyperirritable area on or surrounding the mandible of the patient. This exemplary embodiment or another exemplary embodiment may further include that the second contact member of the second head component defines a diameter that is greater than the contact member of the first head component. This exemplary embodiment or another exemplary embodiment may further include steps of introducing the second head component into an oral cavity of the patient; and contacting an intraoral muscle, via the second contact member, positioned inside of the oral cavity of the patient. This exemplary embodiment or another exemplary embodiment may further include that the step of contacting the intraoral muscle, positioned inside of the oral cavity of the patient further includes that the intraoral muscle is a masseter muscle. This exemplary embodiment or another exemplary embodiment may further include that the step of contacting the intraoral muscle, positioned inside of the oral cavity of the patient further includes that the intraoral muscle is an orbicularis oris muscle. This exemplary embodiment or another exemplary embodiment may further include steps of removing the second head component from the handle; selecting a third head component from the set of head components; connecting the third head component with the handle; actuating the motor, via the switch, from the OFF state to the ON state to vibrate the third head component at the predetermined frequency; locating a third hyperirritable area on or surrounding the mandible of the patient; contacting the third hyperirritable area, via a third contact member of the third head component, on or surrounding the mandible of the patient; and relieving the third hyperirritable area on or surrounding the mandible of the patient. This exemplary embodiment or another exemplary embodiment may further include that the third contact member of the third head component defines a diameter that is greater than the second contact member of the second head component. This exemplary embodiment or another exemplary embodiment may further include steps of introducing the third head component exterior to an oral cavity of the patient; and contacting an extraoral muscle, via the third contact member, positioned outside of the oral cavity of the patient. This exemplary embodiment or another exemplary embodiment may further include that the step of contacting the extraoral muscle positioned outside of the oral cavity of the patient includes the extraoral muscle being a masseter muscle. This exemplary embodiment or another exemplary embodiment may further include that the step of contacting the extraoral muscle positioned outside of the oral cavity of the patient includes the extraoral muscle being a temporalis muscle. This exemplary embodiment or another exemplary embodiment may further include that the step of contacting the extraoral muscle positioned outside of the oral cavity of the patient includes the extraoral muscle being a sternocleidomastoideole. This exemplary embodiment or another exemplary embodiment may further include that the step of contacting the extraoral muscle positioned outside of the oral cavity of the patient includes the extraoral muscle being an upper trapezius muscle. This exemplary embodiment or another exemplary embodiment may further include steps of removing the third head component from the handle; selecting a fourth head component from the set of head components; connecting the fourth head component with the handle; actuating the motor, via the switch, from the OFF state to the ON state to vibrate the fourth head component at the predetermined frequency; locating a fourth hyperirritable area on or surrounding the mandible of the patient; contacting the fourth hyperirritable area, via a fourth contact member of the fourth head component, on or surrounding the mandible of the patient; and relieving the fourth hyperirritable area on or surrounding the mandible of the patient. This exemplary embodiment or another exemplary embodiment may further include that the fourth contact member of the fourth head component defines a different shape than any one of the first, second, and third contact members of the first, second, and third head components. This exemplary embodiment or another exemplary embodiment may further include steps of introducing the fourth head component exterior to an oral cavity of the patient; contacting an extraoral muscle with the fourth contact member that is positioned outside of the oral cavity of the patient; and scraping the extraoral muscle with the fourth contact member; wherein the extraoral muscle is one of a temporalis muscle, sternocleidomastoideole, an upper trapezius muscle, and a masseter muscle.

In yet another aspect, an exemplary embodiment of the present disclosure may provide a myofascial release kit. The myofascial release kit includes a handle. The myofascial release kit also includes a motor operably engaged with the handle, the motor is configured to be operable between an ON state and an OFF state; The myofascial release kit also includes a first head component operably engagable with the handle and operably connectable to the motor. The myofascial release kit also includes a second head component operably engagable with the handle and operably connectable to the motor. The first head component and the second head component are interchangeable with the handle and motor.

This exemplary embodiment or another exemplary embodiment may further provide that the first head component is configured to relieve myofascial pain and dysfunction interior to an oral cavity. This exemplary embodiment or another exemplary embodiment may further provide that each of the first head component and the second head component is configured to relieve myofascial pain and dysfunction exterior to an oral cavity. This exemplary embodiment or another exemplary embodiment may further provide that the motor further comprises a driving vibration element operably engaged with the motor, wherein the driving vibration element is configured to vibrate one of the first head component and a second head component at a predetermined frequency via the motor. This exemplary embodiment or another exemplary embodiment may further provide that the first head component further comprises a base member provided at a first end of the first head component; a support member operably engaged with the base member, wherein the support member is tapered from the first end of the first head component to an opposing second end of the first head component; and a contact member operably engaged with the support member at the second end of the first head component, wherein the contact member is configured to relieve myofascial pain and dysfunction interior to an oral cavity and exterior to an oral cavity. This exemplary embodiment or another exemplary embodiment may further provide that the second head component further comprises a base member provided at a first end of the second head component; a support member operably engaged with the base member, wherein the support member is tapered from the first end of the second head component to an opposing second end of the second head component; and a contact member operably engaged with the support member at the second end of the second head component, wherein the contact member is configured to relieve myofascial pain and dysfunction interior to an oral cavity and exterior to an oral cavity. This exemplary embodiment or another exemplary embodiment may further provide that the support member of the first head component further comprises: a first diameter defined at a first end of the support member of the first head component proximate to the base member of the first head component; and a second diameter defined at an opposing second end of the support member of the first head component proximate to the contact member of the first head component that is less than the first diameter. This exemplary embodiment or another exemplary embodiment may further provide that the contact member of the first head component further comprises: a third diameter defined by the contact member, wherein the third diameter is greater than the second diameter of the support member of the first head component and less than the first diameter of the support member of the first head component. This exemplary embodiment or another exemplary embodiment may further provide that the contact member of the first head component is generally spheroid-shaped. This exemplary embodiment or another exemplary embodiment may further provide that the first head component further comprises a curved formed in the support member between the base member and the contact member, wherein the contact member is offset with the base member. This exemplary embodiment or another exemplary embodiment may further provide that the first head component further comprises a first length measured from the first end of the first head component to the second end of the second head component. This exemplary embodiment or another exemplary embodiment may further provide that the support member of the second head component further comprises a first diameter defined at a first end of the support member of the second head component proximate to the base member of the second head component; and a second diameter defined at an opposing second end of the support member of the second head component proximate to the contact member of the second head component that is less than the first diameter. This exemplary embodiment or another exemplary embodiment may further provide that the contact member of the second head component further comprises: a third diameter defined by the contact member, wherein the third diameter is greater than the second diameter of the support member of the second head component and less than the first diameter of the support member of the second head component, and wherein the third diameter of the contact member of the second head component is greater than the third diameter of the contact member of the first head component. This exemplary embodiment or another exemplary embodiment may further provide that the contact member of the first head component is generally trapezoidal-shaped. This exemplary embodiment or another exemplary embodiment may further include a third head component operably engagable with the handle and operably connectable to the motor; the third head component further comprises: a base member provided at a first end of the third head component; a support member operably engaged with the base member, wherein the support member is tapered from the first end of the third head component to an opposing second end of the third head component; and a contact member operably engaged with the support member at the second end of the third head component, wherein the contact member is configured to relieve myofascial pain and dysfunction interior to an oral cavity and exterior to an oral cavity. This exemplary embodiment or another exemplary embodiment may further provide that the support member of the third head component further comprises a first diameter defined at a first end of the support member of the third head component proximate to the base member of the third head component; and a second diameter defined at an opposing second end of the support member of the third head component proximate to the contact member of the third head component that is less than the first diameter. This exemplary embodiment or another exemplary embodiment may further provide that the contact member of the third head component further comprises a third diameter defined by the contact member, wherein the third diameter is greater than the second diameter of the support member of the third head component and less than the first diameter of the support member of the third head component, and wherein the third diameter of the contact member of the third head component is greater than the third diameter of the contact member of the first head component. This exemplary embodiment or another exemplary embodiment may further provide that the third head component further comprises a second length measured from the first end of the third head component to the second end of the third head component that is less than the first length of the first head component. This exemplary embodiment or another exemplary embodiment may further provide a fourth head component operably engagable with the handle and operably connectable to the motor; the third head component further comprises a base member provided at a first end of the fourth head component; a support member operably engaged with the base member, wherein the support member is tapered from the first end of the fourth head component to an opposing second end of the fourth head component; and a contact member operably engaged with the support member at the second end of the fourth head component, wherein the contact member is configured to relieve myofascial pain and dysfunction interior to an oral cavity and exterior to an oral cavity. This exemplary embodiment or another exemplary embodiment may further provide that the support member of the fourth head component further comprises a first diameter defined at a first end of the support member of the fourth head component proximate to the base member of the fourth head component; and a second diameter defined at an opposing second end of the support member of the fourth head component proximate to the contact member of the fourth head component that is less than the first diameter. This exemplary embodiment or another exemplary embodiment may further provide that the contact member of the fourth head component further comprises a third diameter defined by the contact member, wherein the third diameter is greater than the second diameter of the support member of the fourth head component and less than the first diameter of the support member of the fourth head component, and wherein the third diameter of the contact member of the fourth head component is greater than the third diameter of the contact member of the third head component. This exemplary embodiment or another exemplary embodiment may further provide that the third head component further comprises a third length measured from the first end of the fourth head component to the second end of the fourth head component that is less than the first length of the first head component and the second length of the third head component.

In yet another aspect, an exemplary embodiment of the present disclosure may provide a myofascial release kit. The myofascial release kit includes a handle. The myofascial release kit includes a motor operably engaged with the handle, and the motor is configured to be operable between an ON state and an OFF state. The myofascial release kit includes a first head component operably engagable with the handle and operably connectable to the motor. The myofascial release kit includes a second head component operably engagable with the handle and operably connectable to the motor. The myofascial release kit includes a third head component operably engagable with the handle and operably connectable to the motor. The myofascial release kit includes a fourth head component operably engagable with the handle and operably connectable to the motor. The first head component, the second head component, the third head component, and the fourth head component are interchangeable with the handle and motor.

In yet another aspect, an exemplary embodiment of the present disclosure may provide a method of relieving a hyperirritable area on or surrounding a mandible. The method comprises steps of: providing a myofascial release apparatus (MRA); the MRA comprises: a handle; a motor operably engaged with the handle and configured to generate a mechanical energy; a drive assembly operably engaged with the motor and the handle and configured to generate a vibrational energy; an electrical control assembly electrically connected with the motor for controlling said motor; and a set of head components configured to operably connect with the handle and the drive assembly; selecting a first head component from the set of head components of the MRA; connecting the first head component with the handle of the MRA; locating the hyperirritable area on or surrounding the mandible of a patient experiencing muscle tension; contacting the hyperirritable area, via a contact member of the first head component, on or surrounding the mandible of the patient; actuating the motor of the MRA, via the electrical control assembly of the MRA, from an OFF state to an ON state for vibrating the first head component at at least one predetermined frequency; and relieving the hyperirritable area on or surrounding the mandible.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a top, front, right side isometric perspective view of a myofascial release apparatus with a handle and a head component in accordance with an aspect of the present disclosure.

FIG. 2 (FIG. 2) is a bottom, rear, left side isometric perspective view of the myofascial release apparatus shown in FIG. 1.

FIG. 3 (FIG. 3) is a front elevation view of the myofascial release apparatus shown in FIG. 1.

FIG. 4 (FIG. 4) is a left side elevation view of the myofascial release apparatus shown in FIG. 1.

FIG. 5 (FIG. 5) is a rear elevation view of the myofascial release apparatus shown in FIG. 1.

FIG. 6 (FIG. 6) is a top plan view of the myofascial release apparatus shown in FIG. 1.

FIG. 7 (FIG. 7) is a bottom plan view of the myofascial release apparatus shown in FIG. 1.

FIG. 8 (FIG. 8) is a longitudinal section view of the myofascial release apparatus taken in the direction of line 8-8 shown in FIG. 7.

FIG. 8A (FIG. 8A) is an enlarged view of the handle taken from FIG. 8.

FIG. 8B (FIG. 8B) is an enlarged view of the handle taken from FIG. 8.

FIG. 9 (FIG. 9) is a top, rear, right side isometric perspective view of the head component of the myofascial release apparatus shown in FIG. 1.

FIG. 10 (FIG. 10) is a right side elevation view of the head component shown in FIG. 9.

FIG. 11 (FIG. 11) is a top plan view of the head component shown in FIG. 9.

FIG. 12 (FIG. 12) is an operational view of the myofascial release apparatus with the head component shown in FIG. 1, wherein the myofascial release apparatus is intraorally manipulating a patient's temporomandibular joint.

FIG. 13 (FIG. 13) is another operational view similar to FIG. 12, but the myofascial release apparatus is intraorally manipulating a patient's lateral pterygoid muscle.

FIG. 14 (FIG. 14) is a top, rear, right side isometric perspective view of another head component of the myofascial release apparatus.

FIG. 15 (FIG. 15) is a right side elevation view of the head component shown in FIG. 13.

FIG. 16 (FIG. 16) is a top plan view of the head component shown in FIG. 13.

FIG. 17 (FIG. 17) is an operational view of the myofascial release apparatus with the head component shown in FIG. 14, wherein the myofascial release apparatus is intraorally manipulating a patient's masseter muscle.

FIG. 18 (FIG. 18) is an operational view of the myofascial release apparatus with the head component shown in FIG. 13, wherein the myofascial release apparatus is intraorally manipulating a patient's orbicularis oris muscle.

FIG. 19 (FIG. 19) is a top, rear, right side isometric perspective view of another head component of the myofascial release apparatus.

FIG. 20 (FIG. 20) is a right side elevation view of the head component shown in FIG. 19.

FIG. 21 (FIG. 21) is a top plan view of the head component shown in FIG. 19.

FIG. 22A (FIG. 22A) is an operational view of the myofascial release apparatus with the head component shown in FIG. 19, wherein the myofascial release apparatus is extraorally manipulating a patient's temporalis muscle.

FIG. 22B (FIG. 22B) is another operational view similar to FIG. 22A, but the myofascial release apparatus is extraorally manipulating a patient's masseter muscle.

FIG. 22C (FIG. 22C) is another operational view similar to FIG. 22B, but the myofascial release apparatus is extraorally manipulating a patient's sternocleidomastoideole.

FIG. 22D (FIG. 22D) is another operational view similar to FIG. 22C, but the myofascial release apparatus is extraorally manipulating a patient's upper trapezius muscle.

FIG. 23 (FIG. 23) is a top, rear, right side isometric perspective view of another head component of the myofascial release apparatus.

FIG. 24 (FIG. 24) is a front elevation view of the head component shown in FIG. 23.

FIG. 25 (FIG. 25) is a right side elevation view of the head component shown in FIG. 23.

FIG. 26 (FIG. 26) is a top plan view of the head component shown in FIG. 23.

FIG. 27A (FIG. 27A) is an operational view of the myofascial release apparatus with the head component shown in FIG. 23, wherein the myofascial release apparatus is extraorally scraping a patient's temporalis muscle.

FIG. 27B (FIG. 27B) is another operational view similar to FIG. 27A, but the myofascial release apparatus is extraorally scraping a patient's masseter muscle.

FIG. 27C (FIG. 27C) is another operational view similar to FIG. 27B, but the myofascial release apparatus is extraorally scraping a patient's sternocleidomastoideole.

FIG. 27D (FIG. 27D) is another operational view similar to FIG. 27C, but the myofascial release apparatus extraorally scraping a patient's upper trapezius muscle.

FIG. 28 (FIG. 28) is an exemplary method flowchart for relieving muscle tension surrounding a patient's mandible.

FIG. 29 (FIG. 29) is an exemplary kit of the myofascial release apparatus including a handle and a plurality of interchangeable head components.

FIG. 30 (FIG. 30) is a front elevation view of another myofascial release apparatus with a handle and a head component in accordance with another aspect of the present disclosure.

FIG. 31 (FIG. 31) is a partial sectional view of the handle of the myofascial release apparatus highlighted in FIG. 30.

FIG. 32A (FIG. 32A) is an operational view of the myofascial release apparatus shown in a first or relaxed configuration.

FIG. 32B (FIG. 32B) is an operational view of the myofascial release apparatus shown in a second or flexed configuration.

Similar numbers refer to similar parts throughout the drawings.

### DETAILED DESCRIPTION

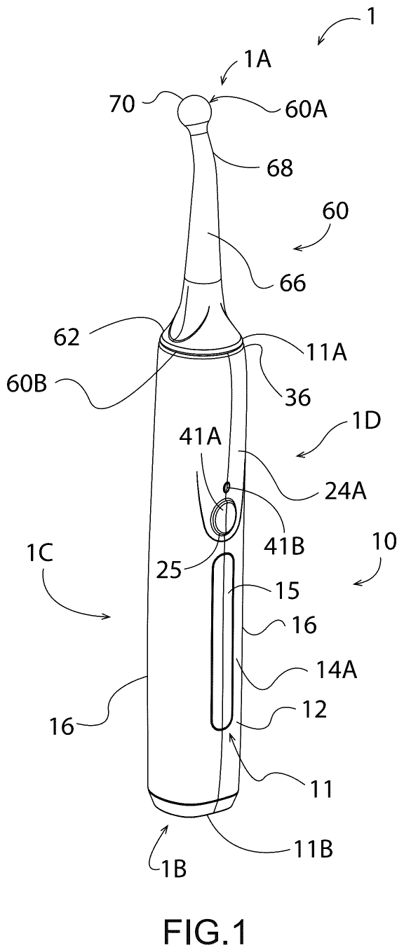

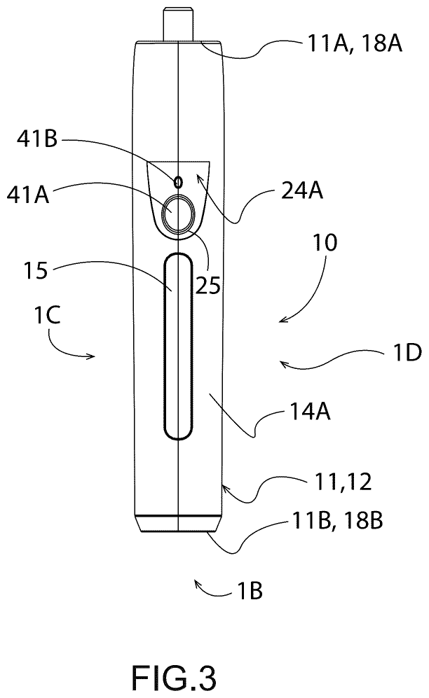

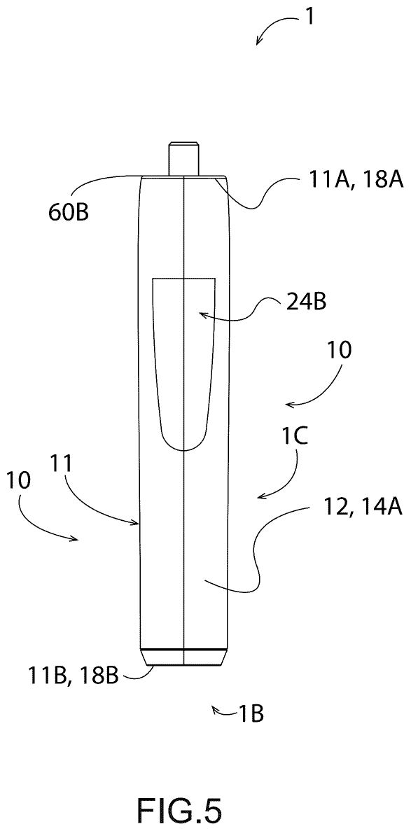

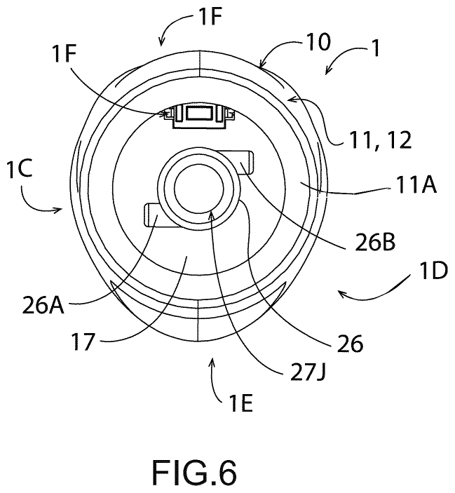

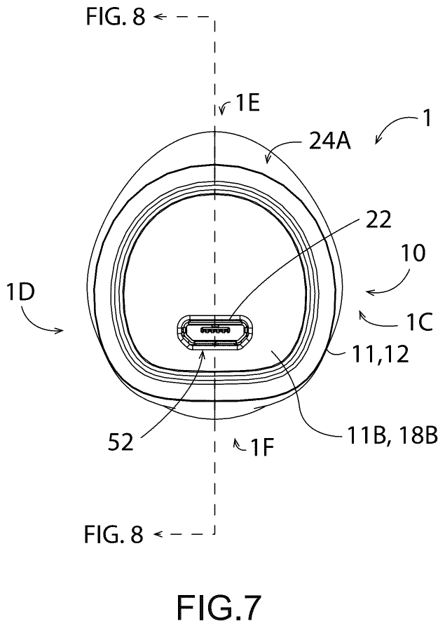

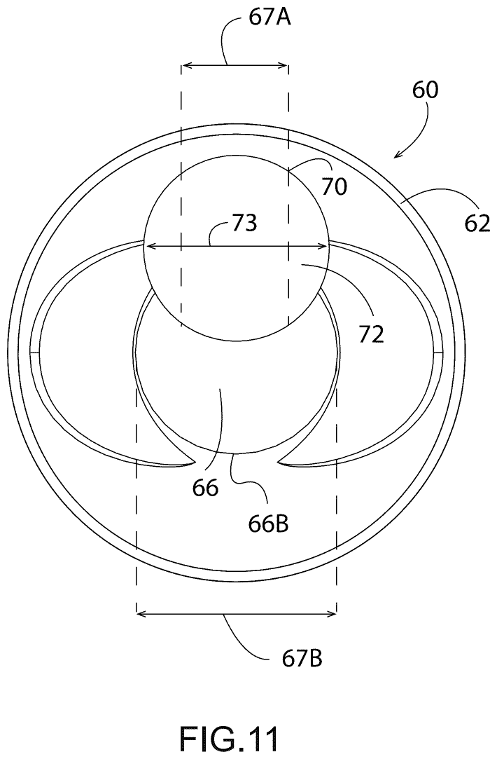

FIGS. 1-13 illustrates a myofascial release apparatus (or “MRA” hereinafter) generally referred to as 1. As illustrated in FIG. 1, MRA 1 may include a top end 1A, an opposing bottom end 1B, and a longitudinal axis defined therebetween. MRA 1 may also include a right or first side 1C, an opposing left or second side 1D, and a transverse axis defined therebetween. MRA 1 may also include a front end 1E, an opposing rear end 1F, and a vertical axis defined therebetween. It should be understood that the terms “front,” “rear,” “left,” “right,” “top,” “bottom”, and directional derivatives used to describe the orientation of MRA 1 illustrated herein should in no way be considered to limit the orientation in which MRA 1 may be utilized during a manipulation treatment.

Still referring to FIG. 1, MRA 1 may include a handle, generally referred to as 10, configured to house various components and devices for generating vibrational energy along with at least one head component generally referred to as 60. The user of MRA 1 may select a desired head component (e.g., head component 60 or head components described herein) to relieve myofascial pain and dysfunction for patient located interior to an oral cavity and/or located exterior to an oral cavity of said patient. Such relieving of myofascial pain and dysfunction for patient, via the at least one head component 60, is described in more detail below.

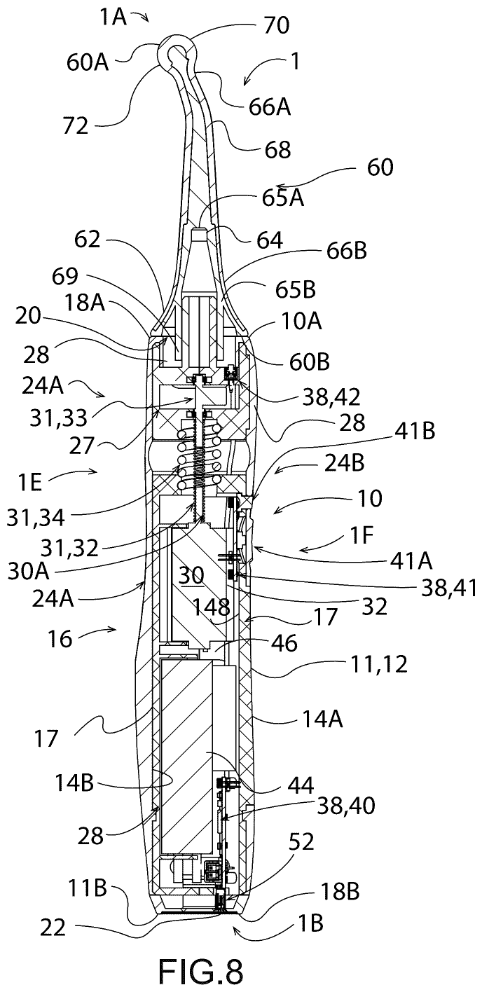

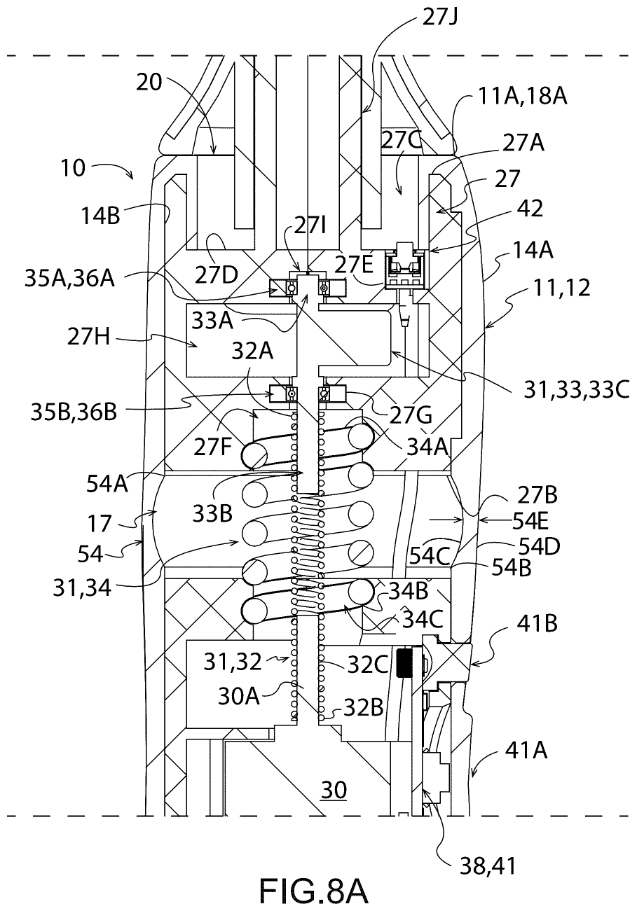

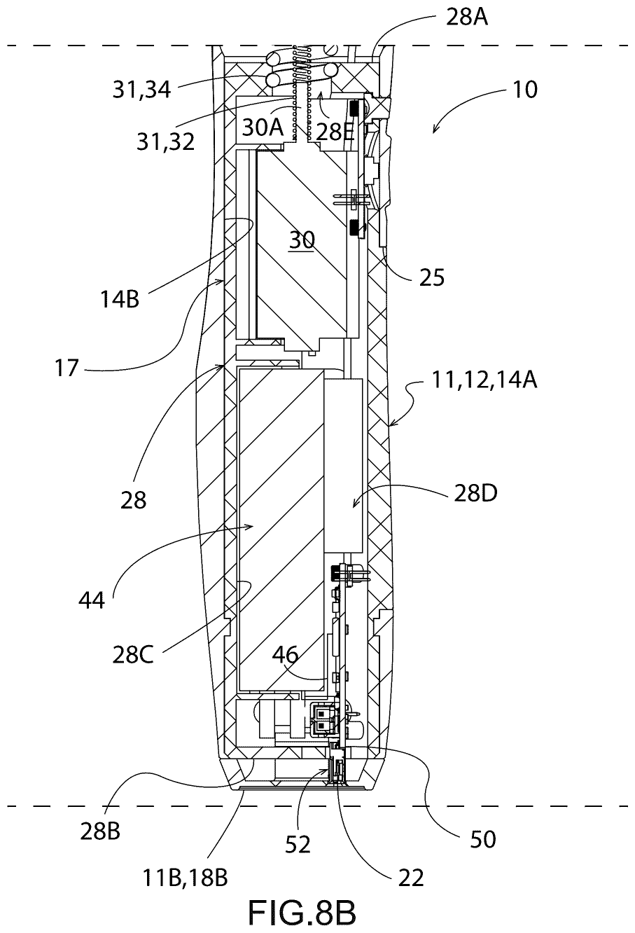

As illustrated in FIGS. 1-5, the handle 10 may include a case 11 configured to house various components and devices for generating vibrational energy. The case 11 includes a top end 11A, and bottom end 11B opposite to the top end 11A, and a longitudinal axis defined therebetween. The case 11 may include a circumferential wall 12 that extends between the top end 11A of the case 11 and the bottom end 11B of the case 11. As shown in FIGS. 1-5, the circumferential wall 12 may include a continuous outer surface 14A that extends from the top end 11A of the case 11 to the bottom end 11B of the case 11. The circumferential wall 12 may also include a continuous inner surface 14B that is opposite to the outer surface 14A and that extends from the top end 11A to the bottom end 11B of the case 11 (see FIG. 8). The circumferential wall 12 also defines a chamber 17 between the top and bottom ends 11A, 11B of the case 11 (see FIG. 8).

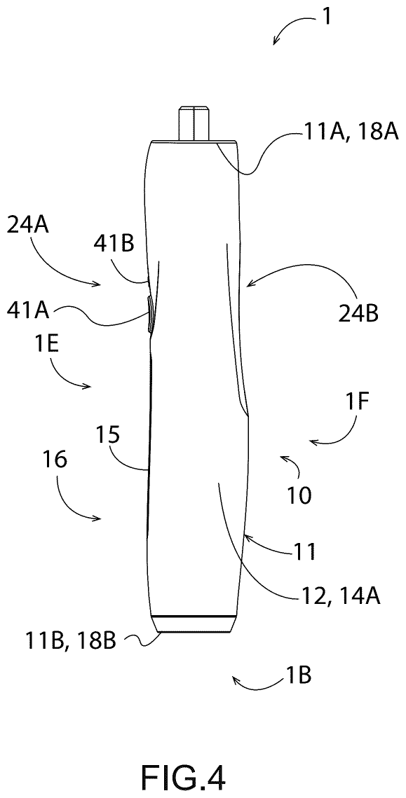

As illustrated in FIGS. 1, 2, and 4, the circumferential wall 12 may define a curve 16 between the top and bottoms ends 11A, 11B of the case 11. In the illustrated embodiment, the curve 16 slightly offsets the top end 11A from the bottom end 11B where the bottom end 11B is vertically forward of the top end 11A on the case 11 (see FIG. 4). More particularly, the curve 16 of the case 11 is S-shaped and defined between the top and bottom ends 11A, 11B of the case 11. The S-shaped configuration of the case 11 may allow for ergonomic benefits and relief for the user of the MRA 1 when performing treatments on a patient. In other exemplary embodiment, a circumferential wall of a handle provided herein may have suitable shape or configuration based on desired needs, including ergonomic benefits, stability and/or support benefits, and other suitable desires.

Referring to FIG. 8, the case 11 includes a top surface 18A proximate to the top end 11A of the case 11 and a bottom surface 18B that is opposite to the top surface 18A and proximate to the bottom end 11B of the case 11. The case 11 defines a top opening 20 in the top surface 18A of the case 11. The top opening 20 provides access to the chamber 17 where the chamber 17 and the external environment of the case 11 are in fluid communication via the top opening 20. The case 11 also defines a bottom opening 22 in the bottom surface 18B of the case 11 opposite to the top opening 20. The bottom opening 22 also provides access to the chamber 17 where the chamber 17 and the external environment of the case 11 are in fluid communication via the bottom opening 22. Such uses and purposes of the top and bottom openings 20, 22 are described in more detail below.

Still referring to FIG. 8, the case 11 also defines a front indentation 24A in the circumferential wall 12. The front indentation 24A is defined between the top and bottom ends 11A, 11B of the case 11 proximate to the top end 11A of the case 11. As shown in FIG. 8, the front indentation 24A extends inwardly towards the rear end 1F of the MRA 1 where the front indentation 24A is adapted to receive a first digit of a user (e.g., an index finger of a user) when using the MRA 1. The case 11 also defines an opposing rear indentation 24B in the circumferential wall 12. The rear indentation 24B is defined between the top and bottom ends 11A, 11B of the case 11 proximate to the top end 11A of the case 11. As shown in FIG. 8, the rear indentation 24B extends inwardly towards the front end 1E of the MRA 1 where the rear indentation 24B is adapted to receive a second digit of a user (e.g., a thumb of a user) when using the MRA 1.

As best seen in FIG. 8, the front and rear indentations 24A, 24B are aligned with one another relative to the longitudinal axis of the case 11. The locations of the front and rear indentations 24A, 24B allow a user to apply a pinching or squeezing force with first and second digits against the case 11 inside of the front and rear indentations 24A, 24B. In other words, the front and rear indentations 24A, 24B defined in the circumferential wall 12 of the case 11 provides the user with additional grip support when holding and using the MRA 1 during treatments. The user's remaining digits may grasp below the front and rear indentations 24A, 24B when using the MRA 1 during treatments. In the illustrated embodiment, the front and rear indentations 24A, 24B are curvilinear shaped, more particularly ovoidal, to match the shape of a user's digits. In other exemplary embodiments, first and second indentations of a handle may define any suitable shape or configuration to allow a user to grip a handle when using a MRA during a treatment.

Still referring to FIG. 8, the case 11 may define a side opening 25 in the circumferential wall 12 where the outer and inner surfaces 14A, 14B are in fluid communication with one another via the side opening 25. The side opening 25 is defined between the top end 11A and the bottom end 11B proximate to the top end 11A. As seen in FIG. 8, the side opening 25 is aligned inside of the front indentation 24A. Such use and purpose of aligning the side opening 25 inside of the front indentation 24A is described in more detail below.

Case 11 may also include at least one engagement member 26 that enables the head component 60 to operably engage with the handle 10. In the illustrated embodiment, case 11 may include a first engagement member 26A that extends outwardly from the circumferential wall 12, particularly the inner surface 14B. Case 11 may also include a second engagement member 26B that extends outwardly from the circumferential wall 12, particularly the inner surface 14B. In this illustrated embodiment, the second engagement member 26B is positioned opposite to the first engagement member 26A to enable the first engagement member 26A and the second engagement member 26B to operably engage with the head component 60 at opposing positions; such interlocking engagement between the first engagement member 26A, the second engagement member 26B, and the head component 60 is described in more detail below.

Handle 10 may also include a first or upper support 27 that may operably engage with the case 11 inside the chamber 17. As best seen in FIG. 8, the upper support 27 operably engages with the inner surface 14B of the case 11 inside the chamber 17. In the illustrated embodiment, the case 11 and the upper support 27 may be separate component that operably engage with one another. In one exemplary embodiment, a case and an upper support described and illustrated herein may be a single, integral part such that the case and the upper support form a single, unitary member.

As best seen in FIG. 8A, upper support 27 may include a top end 27A, a bottom end 27B opposite to the top end 27A, and a longitudinal axis defined therebetween. Upper support 27 may define a recess 27C that extends downwardly from the top end 27A to an intermediate wall 27D. Upper support 27 may also define an upper cavity 27E that extends downwardly from the intermediate wall 27D and into the upper support 27. Upper support 27 may also define a lower cavity 27F that extends upwardly into the upper support 27 from the bottom end 27B towards the top end 27A. Upper support 27 may also define a lower channel 27G that extends between the lower cavity 27F and an intermediate chamber 27H defined in the upper support 27; the lower channel 27G provides fluid communication between the lower cavity 27F and the intermediate chamber 27H. Upper support 27 may also define an upper channel 271 that is in fluid communication with the intermediate chamber 27H. As described in more detail below, the upper support 27 provides structural support to various mechanical and electrical devices configured to generate vibrational energy for myofascial release of trigger points or hyperirritable areas.

Upper support 27 may also include a vibration transfer element or connection 27J. As such best in FIG. 8, vibration transfer element 27J may extend upwardly from intermediate wall 27D of upper support 27 and through the recess 27C in which a portion of the vibration transfer element 27J is positioned outside of the upper support 27 and case 11. As described in more detail below, the vibration transfer element 27J is configured to transfer vibrational energy from the handle 10 to the head component 60 when the head component 60 operably connects with the handle 10.

Handle 10 may also include a second or lower support 28 that operably engages with the case 11 inside the chamber 17. More particularly, the lower support 28 operably engages with the inner surface 14B of the case 11 inside the chamber 17 and vertically opposite to the upper support 27. In the illustrated embodiment, the case 11 and the lower support 28 may be separate component that operably engage with one another. In one exemplary embodiment, a case and a lower support described and illustrated herein may be a single, integral part such that the case and the lower support form a single, unitary member.

As best seen in FIG. 8B, lower support 28 includes a top end 28A, a bottom end 28B opposite to the top end 28A, and a longitudinal axis defined therebetween. Lower support 28 may also include a circumferential wall 28C that extends longitudinally between the top end 28A and the bottom end 28B. A chamber 28D may also be collectively defined by the top end 28A, the bottom end 28B, and the circumferential wall 28C. Lower support 28 may also define a top opening 28E at the top end 28A of the lower support 28 which provides access into the chamber 28D. As described in more detail below, the lower support 28 also provides structural support to various mechanical and electrical devices configured to generate vibrational energy for myofascial release of trigger points or hyperirritable areas.

An intermediate cavity 29 is also defined between the upper support 27 and the lower support 28 such that the intermediate cavity 29 is part of the chamber 17. As described in more detail below, the upper support 27 and the lower support 28 provides structural support to various mechanical and electrical devices configured to generate vibrational energy for treating trigger points or hyperirritable areas experienced by a patient.

Still referring to FIG. 8, the handle 10 may include a vibration motor 30 operably engaged with the lower support 28. More particularly, vibration motor 30 is provided inside of and operably engages with the lower support 28 that is operably engaged with the case 11. As described in more detail below, the vibration motor 30 is configured to produce mechanical energy via rotational force to a drive assembly (described in more detail below) to enable the at least one head component 60 to provide a myofascial massage or manipulation to an applied area (either intraorally or extraorally).

In the illustrated embodiment, the vibration motor 30 may be configured to have variable speeds and/or intensities for generating vibrational energy to the head component 60. During operation, the intensity and frequency of the vibrational energy generated by the vibration motor 30 may be calibrated for intraoral and extraoral muscle groups used to treat pain and discomfort causing the patient's TMJ disorder. As such, the user may be able to vary the speed and intensity of the vibrational energy depending on the type of muscle group being treated inside of a patient's oral cavity or outside of a patient's oral cavity. In this MRA 1, the intensity and frequency of the vibrational energy must be at a desired setting to prevent against pain and reduction in therapeutic effectiveness when treating TMJ disorder or other related disorders.

Handle 10 may also include a drive assembly 31 that operably engaged with the vibration motor 30. In general, the drive assembly 31 is configured to transfer the mechanical energy produced by the vibration motor 30 to the head component 60, which is described in more detail below. During operation, the vibration motor 30 transmits the mechanical energy to the drive assembly 31 which is ultimately transmitted to the at least one head component 60. Such components and elements of drive assembly 31 are described in greater detail below.

Drive assembly 31 may include an inner connection 32 that operably engages with a drive shaft 30A of the vibration motor 30. In the illustrated embodiment, inner connection 32 is a spring that transfer the mechanical energy from the vibration motor 30 to the head component 60. In other exemplary embodiments, inner connection 32 may be any suitable component and/or element that may transfer the mechanical energy from the vibration motor 30 to the head component 60. Inner connection 32 includes a first end 32A that operably engages with the drive shaft 30A of vibration motor 30. Inner connection 32 may also include a second end 32B that is opposite to the first end 32A and operably engages with a vibration weight of drive assembly 31, which is described in more detail below. Inner connection 32 may also define a passageway 32C that extends between the first end 32A and the second end 32B where each of the first end 32A and the second end 32B is an open end to allow access into the passageway 32C.

Drive assembly 31 may also include a vibration weight 33 that operably engages with the inner connection 32. As best seen in FIG. 8, vibration weight 33 may include a first shaft 33A that operably engages with the upper support 27 inside of the upper channel 271. The first shaft 33A is also partially disposed inside of the lower cavity 27F and the lower channel 27G. Vibration weight 33 may also include a second shaft 33B that is opposite to the first shaft 33A and that operably engages with the inner connection 32. More particularly, the second shaft 33B operably engages with the first end 32A of the inner connection 32 where the second shaft 33B is positioned inside of the passageway 32C defined in the inner connection 32. While the first shaft 33A and the second shaft 33B may be separate components in vibration weight 33, first and second shafts in a vibration weight described herein may collectively define a single shaft for a vibration weight described herein,

Vibration weight 33 may also include an offset mass 33C that operably engages with the first shaft 33A and the second shaft 33B. As best seen in FIG. 8, offset mass 33C may be positioned between the first shaft 33A and the second shaft 33B while being offset from the first shaft 33A and the second shaft 33B to create a counterbalance. Such use of offset mass 33C is considered advantageous at least because the offset mass 33C generates vibrational energy inside of the case 11 upon receiving mechanical energy (i.e. rotational force) from inner connection 32 that was originally generated by the vibration motor 30. As described in more detail below, the vibrational energy generated by the vibration weight 33 is then transferred to the head component 60 for treating trigger points or hyperirritable areas experienced by a patient.

Drive assembly 31 may include an outer connection 34 that operably engages with the upper support 27 and the lower support 28. In the illustrated embodiment, outer connection 34 is a spring that transfer the mechanical energy from the lower support 28 to the upper support 27. In other exemplary embodiments, outer connection 34 may be any suitable component and/or element that may transfer the mechanical energy from the lower support 28 to the upper support 27. Outer connection 34 includes a first end 34A that operably engages with the upper support 27, particularly at the bottom end 27B inside of the lower cavity 27F. Outer connection 34 may also include a second end 34B that is opposite to the first end 34A and operably engages with the lower support 28, particularly at the top end 28A and inside of the top opening 28E. Outer connection 34 may also define a passageway 34C that extends between the first end 34A and the second end 34B where each of the first end 34A and the second end 34B is an open end to allow access into the passageway 34C. The passageway 34C is also configured to receive and house the drive shaft 30A of vibration motor 30 along with inner connection 32 upon assembly of handle 10.

Drive assembly 31 may also include at least one roller bearing that operably engages with one or both of the first shaft 33A and the second shaft 33B for providing rotational and/or axial support to one or both of the first shaft 33A and the second shaft 33B. As best seen in FIG. 8, drive assembly 31 includes an upper roller bearing 35A that operably engages with the first shaft 33A of vibration weight 33. Upper roller bearing 35A also operably engages with the upper support 27 inside of the upper channel 271. As such, upper roller bearing 35A provides rotational and/or axial support to the first shaft 33A. Drive assembly 31 includes a lower roller bearing 35B that operably engages with the second shaft 33B of vibration weight 33. Lower roller bearing 35B also operably engages with the upper support 27 inside of the lower channel 27G. As such, lower roller bearing 35B provides rotational and/or axial support to the second shaft 33B.

Still referring to FIG. 8, the handle 10 may include at least one isolator 36. In one instance, a first isolator 36A may operably engage with the upper roller bearing 35A. The first isolator 36A may also be operably engaged with the upper support 27 inside of the upper channel 271. In this same instance, a second isolator 36B may operably engage with the lower roller bearing 35B. The second isolator 36B may also be operably engaged with the lower support 28 inside of the lower channel 27G.

The first isolator 36A and the second isolator 36B are positioned radially about the upper roller bearing 35A and the lower roller bearing 35B inside of the upper channel 271 and the lower channel 27G defined in upper support 27. Moreover, the first isolator 36A and the second isolator 36B may be made from soft and resilient material to isolate the vibrational energy towards the driving vibration element 27J and absorb said vibrational energy away from the circumferential wall 12. In other words, the first isolator 36A and the second isolator 36B may be configured to direct unwanted vibrational energy away from the case 11 and towards the head component 60 for providing a suitable massaging to a patient's trigger point, which is described in more detail below.

Still referring to FIG. 8, the vibration motor 30 is controlled via an electrical control assembly 38. As illustrated in FIG. 8, the electrical control assembly 38 includes a main or primary logic controller 40 that is electrically connected with the vibration motor 30. The primary logic controller 40 is configured to control the vibration motor 30 based on various parameters, including, but not limited to, powering the vibration motor 30 between an ON and OFF states, controlling the output of mechanical energy and/or rotational force created by the vibration motor 30, and other parameters considered suitable to control over the vibration motor 30 via the primary logic controller 40. In the illustrated embodiment, the logic controller 40 is a printed circuit board (or PCB) that operably controls the vibration motor 30 during ischemic compression therapies and myofascial releases on the patient.

In addition, electrical control assembly 38 may further include a secondary logic controller 41 that electrically connects with the primary logic controller 40. As described in more detail below, the secondary logic controller 41 enables a patient and/or user to use MRA 1 by interacting with the secondary logic controller 41 through elements electrically connected with the secondary logic controller 41. In addition, a switch 41A may electrically connect with the secondary logic controller 41 to enable a patient and/or user to interact with MRA 1. In the illustrated embodiment, the switch 41A is a push button switch operably engaged with the circumferential wall 12 inside of the side opening 25. The switch 41A is configured to actuate the vibration motor 30, via the primary logic controller 40 and secondary logic controller 41, between ON and OFF states. In operation, a user may actuate the switch 41A from an OFF state to an ON state so that the vibration motor 30 creates mechanical energy which is used to generate vibrational energy to the head component 60, via drive assembly 31, for a myofascial release at a specific trigger point or hyperirritable area. During operation, the user may then actuate the switch 41A from the ON state to the OFF state to cease production of mechanical energy by the vibration motor 30 once myofascial release treatment is complete. The user may also vary the intensity and frequency of the vibrational wave and/or energy through the electrical control assembly 38 by controlling the mechanical energy outputted by the vibration motor 30 when toggling the switch 41A. In one exemplary embodiment, a switch of a MRA may be configured to allow a user of the MRA to toggle through various ranges of frequencies created by a vibration motor of the MRA when using a specific head component, which is described in more detail below.

Additionally, a light source 41B (e.g., a light emitting diode or LED) may also be electrically connected to the secondary logic controller 41. The light source 41B may be used to indicate and/or signal to the patient or user a particular mode and/or state of MRA 1 during use. In one instance, the light source 41B may indicate to the patient or user when the vibration motor 30 is provided in the ON state or in the OFF state after toggling the switch 41A. In another instance, the light source 41B may indicate to the patient and/or user when a specific mode or motor speed has been selected upon toggling the switch 41A (e.g., a first light signifying low or slow speed, a second light signifying a medium or intermediate speed greater than the slow speed, and a third light signifying a high or fast speed that is greater than both the slow and intermediate speed). In yet another instance, the light source 41B may indicate to the patient and/or user the power state of the MRA 1 during use.

Electrical control assembly 38 may also include a head sensor switch 42 that electrically connects with the primary logic controller 40. In the illustrate embodiment, head sensor switch 42 is positioned inside of chamber 17 defined by case 11 and operably engages with the upper support 27 inside of the upper cavity 27E. In one exemplary embodiment, the head sensor switch 42 may be positioned exterior to the chamber 17 defined by the case 11 and may be operably engaged with upper support 27 or case 11. During operation, the head sensor switch 42 may be actuated by at least one head component described and illustrated herein; such actuation by at least one head component is described in more detail below. Once actuated, the head sensor switch 42 may send at least one signal to the primary logic controller 40 to enable a specific mode and/or set of parameters to the vibration motor 30. In one instance, at least one head component (described herein) may actuate the head sensor switch 42 sending at least one signal to the primary logic controller 40 to enable at least one mode and/or set of parameters to the vibration motor 30. In this same instance, at least another head component (described herein) may actuate the head sensor switch 42 sending at least another signal to the primary logic controller 40 to enable at least another mode and/or set of parameters to the vibration motor 30 where the at least another mode is different than the at least one mode previously mentioned in this instance.

The use of the head sensor switch 42 is considered advantageous at least because the head sensor switch 42 automatically sets the primary logic controller 40 to a predetermined setting and/or mode when a specific head component described herein actuates the head sensor switch 42 and interlocks with the case 11. Such automatic setting of the primary logic controller 40 may also enable the primary logic controller 40 to configure the vibration motor 30 to a desired mode or parameter for providing suitable mechanical energy to the drive assembly 31 for generating suitable vibrational energy to the specific head component. Such automatic configuration of MRA 1 provides ease of using MRA 1 without the need to select or toggle between treatment settings.

Still referring to FIG. 8, the handle 10 may include an energy storage device 44 operably connected with the vibration motor 30 and the components provided in electrical control assembly 38. In the illustrated embodiment, the energy storage device 44 is adapted to provide electrical power to the vibration motor 30 in order for the vibration motor 30 to create vibrational waves. The energy storage device 44 is operably connected to the vibration motor 30 via a first electrical connection or wire 46 connecting from an output port of the energy storage device 44 to an input port of the vibration motor 30. In the illustrated embodiment, the energy storage device 44 is a battery. In other exemplary embodiments, any suitable energy storage device may be used herein to power a vibration motor and other electrical components in a handle of a MRA. In one exemplary embodiment, a MRA may be power by an external power source (i.e., external battery or wall outlet) through an external electrical cord operably connected with a vibration motor of the MRA.

Still referring to FIG. 8, a second electrical connection 50 may be operably connecting the energy storage device 44 with a charge connector 52. In the illustrated embodiment, the energy storage device 44 may be a rechargeable battery that is adapted to be charged via an external power source (e.g., external battery, wall outlet, etc.). As such, the second electrical connection 50 transmits electrical charge from the charge connector 52 to the energy storage device 44. The charge connector 52 may be operably engaged with the handle 10 at the bottom end 11B of the handle 10 inside of the bottom opening 22.

Referring to FIG. 8, the case 11 of handle 10 also includes a deformable wall portion 54. In the present disclosure, deformable wall portion 54 includes a first end 54A that operable engages with the bottom end 27B of the upper support portion 27. Deformable wall portion 54 also includes a second end 54b vertically opposite to the first end 54A and operable engages with the top end 28A of the lower support portion 28. Deformable wall portion 54 also includes an internal surface 54C that faces into the chamber 17 and extends vertically between the first end 54A and the second end 54B. In the present disclosure, internal surface 54C defines a curvilinear shape between the first and second ends 54A, 54B to assist the case 11 in bending and/or deforming when a predetermined pressure is applied during use. Deformable wall portion 54 also includes an exterior surface 54D that is in communication with the environment surrounding the handle 10 and extends vertically between the first end 54A and the second end 54B. As best seen in FIG. 8A, the thickness 54E tapers inwardly from the first end 54A to a medial point of the deformable wall portion 54 and tapers inwardly from the second end 54B to the medial point of the deformable wall portion 54; such varied thickness enables the handle 10 to bend and/or flex at such deformable wall portion 54, which is discussed in greater detail below.

In operation, the deformable wall portion 54 bends and/or flexes the case 11 between the upper support portion 27 and the lower support portion 28 when the pressure applied to the MRA 1 meets a predetermined pressure threshold of said deformable wall portion 54. Stated differently, the deformable wall portion 54 bends and/or deforms when the user or patient exerts a force onto a head component (discussed below) of the MRA 1 that is greater than a bending stress or strength of the deformable wall portion 54 to prevent harmful, and potentially damaging, pressure applied to the user's or patient's myofascial point by said MRA 1. In one instance, the deformable wall portion 54 remains at a first or relaxed configuration (see FIG. 8) when the pressure applied to the head component of the MRA 1 is less than the bending strength of the deformable wall portion 54. In this instance, the top end 11A of case 11 and the bottom end 11B of case 11 are aligned with one another relative to the longitudinal axis of the case 11. In another instance, the deformable wall portion 54 translates to a second or flexed configuration when the pressure applied to the head component of the MRA 1 is greater than the bending strength of the deformable wall portion 54. In this instance, the top end 11A of case 11 and the bottom end 11B of case 11 are offset from one another relative to the longitudinal axis of the case 11. In the flexed configuration, the inner connection 32 may bend resulting in a reduction of energy or mechanical power between the vibration weight 33 and the vibration motor 30 to prevent harmful or unwanted pressure at the patient's myofascial point.

Such deformable wall portion 54 is considered advantageous at least because such deformation of the case 11 prevents harmful or damaging pressure applied to a patient's myofascial point or affected area. With such deformable wall portion 54, users or patients that operate MRA 1 have a built-in safety mechanism to prevent further damage or harm when using one or more types of head components for relieving one or more myofascial points or affected areas.

As illustrated in FIGS. 1-2, 8, and 12-13, a first head component 60 is operably engaged with the handle 10, particularly the case 11 and the upper support 27. The head component 60 may be removable from the case 11 and the upper support 27, specifically the driving vibration element 27J, for various reasons, including changing from a first head component 60 to another head component for different treatment to the patient (described in detail below). The head component 60 is also configured to relieve myofascial pain and dysfunction interior to an oral cavity including the temporomandibular joint, the lateral pterygoid muscle, and the medial pterygoid muscle, which is described in more detail below. In this illustrated embodiment, the head component 60 is primarily used as an intraoral head component 60 for providing ischemic compression treatment at specific trigger points or hyperirritable areas interior to the patient's oral cavity. In addition, however, the head component 60 may be configured to relieve myofascial pain and dysfunction exterior to an oral cavity including a patient's temporalis muscle, a patient's lateral pterygoid muscle, a patient's medial pterygoid muscle, a patient's masseter muscle, a patient's sternocleidomastoideole, and a patient's trapezius muscle, which is described in more detail below.

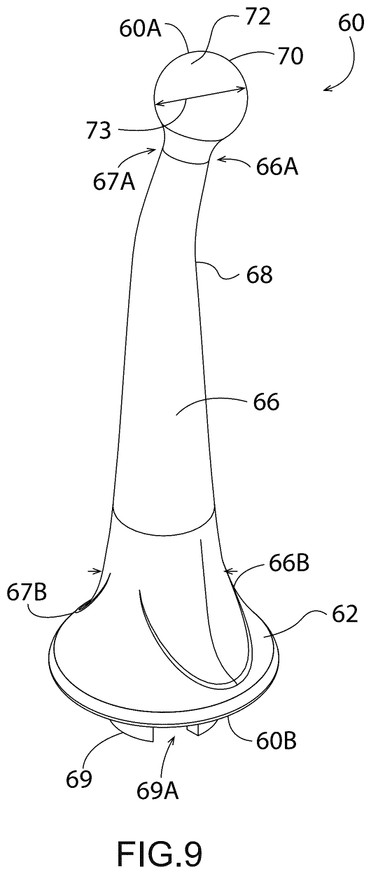

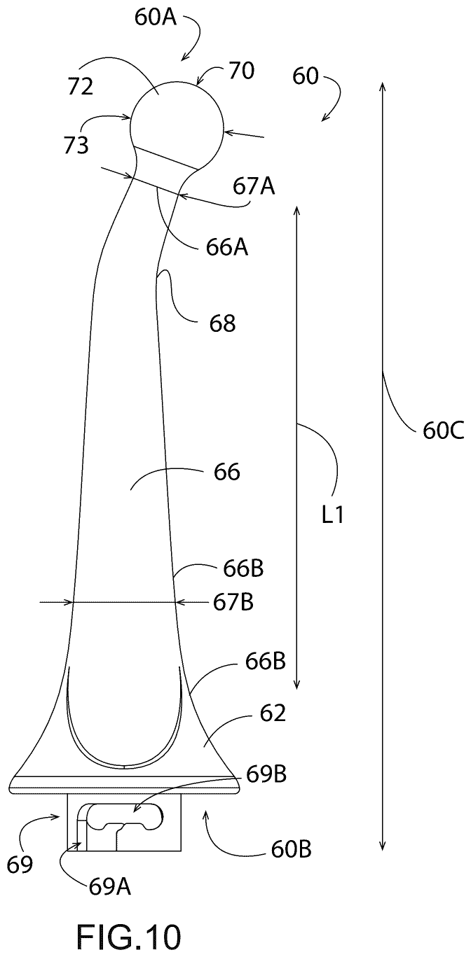

As illustrated in FIGS. 9-11, the head component 60 may include a first end or top end 60A, an opposing second end or bottom end 60B, and a length 60C that measures from the top end 60A to the bottom end 60B (see FIG. 10). In the illustrated embodiment, the length 60C of the head component 60 is about sixty millimeters in length. In other exemplary embodiments, a head component may have any suitable length for providing intraoral and extraoral treatment in regards to TMJ disorder. Such length 60C of the head component 60 is considered advantageous at least because the length 60C provides the user with another reachability to contact and treat joints and muscles intraorally of the patient's oral cavity to treat TMJ disorder while not be a choking hazard.

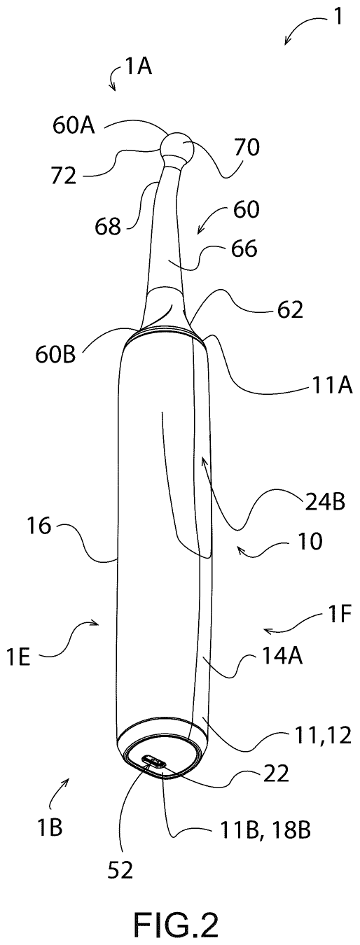

The head component 60 may include a base member 62 proximate to the bottom end 60B of the head component 60. As illustrated in FIGS. 1-2, the base member 62 directly abuts the top end 11A of the case 11 when the head component 60 is provided on the handle 10. The base member 62 is also tapered from the bottom end 60B of the head component 60 towards the top end 60A of head component 60. Such taper of the base member 62 may allow for greater range of inserting the head component into a patient's oral cavity to perform ischemic compression treatment at specific trigger points or hyperirritable areas for treating temporomandibular joint (TMJ) disorder (e.g., massaging the TMJ joint or muscles surrounding the TMJ joint).

Referring to FIG. 8, the head component 60 may include a receiving member 64 that extends from the bottom end 60B of the head component 60 towards the top end 60A of the head component 60. The receiving member 64 also defines a cavity 65A therein being accessible via a lower opening 65B defined in the bottom end 60B of the head component 60. The cavity 65A and lower opening 65B are sized and configured to allow the receiving member 64 of the head component 60 to operably engage with a portion of the driving vibration element 27J. In other words, the diameter of the receiving member 64 is substantially equal to the diameter of the driving vibration element 27J where the driving vibration element 27J engages with the receiving member 64 of the head component. Such engagement between the receiving member 64 of the head component 60 and the driving vibration element 27J of the handle 10 allows for the head component 60 to receive the vibrational energy generated by the vibration motor 30 and the drive assembly 31 to perform myofascial massaging and relief to a trigger point or hyperirritable area of a patient that is interior to or exterior to the patient's oral cavity.

Still referring to FIGS. 9-11, the head component 60 may include a support member 66 that extends from the base member 62 towards the top end 60A of the head component 60. The support member 66 may a first end or upper end 66A proximate to the top end 60A of the head component 60 and an opposing second end or lower end 66B proximate to the base member 62. As illustrated in FIG. 4, the support member 66 defines a first length “L1” that extends from the upper end 66A to the lower end 66B. Moreover, the support member 66 also tapers from the lower end 66B to the upper end 66A where the support member 66 defines a first diameter 67A proximate to the upper end 66A and a second diameter 67B proximate to the lower end 66B; the second diameter 67B is greater than the first diameter 67A. Such taper of the support member 66 may allow for greater range of inserting the head component 60 into a patient's oral cavity to perform ischemic compression treatment at specific trigger points or hyperirritable areas for treating temporomandibular joint (TMJ) disorder (e.g., massaging the TMJ joint or muscles surrounding the TMJ joint). In the illustrated embodiment, the support member 66 may have a taper that ranges from about two millimeters up to about four millimeters between the top and bottom ends 60A, 60B.

Still referring to FIG. 4, the support member 66 may also define a curve or bend 68 that is defined between the upper and lower ends 66A, 66B. The bend 68 of the support member 66 offsets the upper end and the lower ends 66A, 66B. In the illustrated embodiment, the upper end 66A is positioned forwardly of the lower end 66B due to the inclusion of the bend 68. In other exemplary embodiments, a bend of a support member may be defined at any suitable angle relative to a longitudinal axis of a head component based on various considerations. The inclusion of the bend 68 in the support member 66 may allow for greater range of inserting the head component 60 into a patient's oral cavity to perform ischemic compression treatment at specific trigger points or hyperirritable areas for treating temporomandibular joint (TMJ) disorder (e.g., massaging the TMJ joint or muscles surrounding the TMJ joint). Moreover, the inclusion of the bend 68 in the support member 66 may provide a user with an ample amount of leverage to perform ischemic compression therapy at specific trigger point or hyperirritable area interior to a patient's oral cavity, specifically the TMJ or muscles surrounding and attaching to the TMJ. Such ample amount of leverage may be enough to allow for resurgence of blood flow into an ischemic trigger point or hyperirritable area and to alleviate mandible pain or discomfort.

Head component 60 may include at least one attachment member 69 that operably engages with and/or interlockingly engages with the at least one engagement member 26. As best seen in FIGS. 9 and 10, head component 60 may include a single attachment member 69 that operably engages with the base member 62 and extends away from the base member 62 and the bottom end 60B. The attachment member 69 may define a first attachment opening 69A and a second attachment opening 69B. In the illustrated embodiment, the first attachment opening 69A and the second attachment opening 69B enables the first engagement member 26A and the second engagement member 26B to operably engage with the attachment member 69 for interlocking the head component 60 with the case 11. As such, the head component 60 is releasably secured with case 11 once the attachment member 69 interlocks with the the first engagement member 26A and the second engagement member 26B.

While the attachment member 69 may interlockingly engage with the engagement member 26 of case 11, a head component may interlockingly engage with a case is other suitable configurations. In one exemplary embodiment, a receiving member (e.g., receiving member 64) may interlockingly engage with a driving vibration element (e.g., driving vibration element 27J). In another exemplary embodiment, a head component may interlockingly engage with an isolator of a handle to maintain the head component with the handle. In yet another exemplary embodiment, a bottom end of a head component may interlockingly engage with a top end of a handle to maintain the head component with the handle. In other exemplary embodiments, a head component may be operably engaged with a handle in a suitable configuration to maintain the head component with the handle to perform treatment on a patient.

Referring to FIGS. 9-11, the head component 60 may also include a bulbous contact member 70. In the illustrated embodiment, the contact member 70 may be operably engaged with the support member 66, specifically at the upper end 66A of the support member 66. The contact member 70 may include a contact surface 72 positioned at the top end 60A of the head component. The contact member 70 defines a bulbous or rounded shape in which the contact surface 72 that is atraumatic. In other words, the contact member 70 is configured to prevent tissue damage or injury to a patient that is interior to the patient's oral cavity and/or exterior to the patient's oral cavity while performing ischemic compression therapy or a myofascial massage or manipulation.

Moreover, the contact member 70 may define a first material that is softer and/or more resilient than a second material that makes up the base member 62 and the support member 66 (see FIG. 8). Any suitable soft or resilient medical grade material may be used for the contact member 70 to suitably provide ischemic compression therapy and myofascial massage or manipulation treatment while not injuring or damaging soft tissue, muscle, or bones interior to or exterior to a patient's oral cavity.

Still referring to FIG. 4, the contact member 70 may also define a third diameter 73. The third diameter 73 of the contact member 70 is greater than the first diameter 67A of the support member 66. Such difference in diameter between the contact member 70 and the upper end 66A of the support member 66 may allow for greater range of inserting the head component 60 into a patient's oral cavity during an ischemic compression therapy for treating TMJ disorder (e.g., massaging the TMJ joint or muscles surrounding the TMJ joint). In the illustrated embodiment, the contact member 70 may define a diameter of about seven and one-half millimeters. In other exemplary embodiments, a contact member may define any suitable diameter that is adapted to contact and massage the area surrounding the patient's TMJ.

Still referring to FIG. 4, the contact member 70 is offset from the base member 62 and the lower end 66B of the support member 66 due to the bend 68 defined in the support member 66. Such offset of the contact member 70 may allow for greater range of inserting the head component 60 into a patient's oral cavity during an ischemic compression therapy and myofascial massage or manipulation for TMJ disorder relief (e.g., massaging the TMJ joint or muscles surrounding the TMJ joint).

Having now described the components and assemblies of MRA 1, methods of using the MRA 1 for treating TMJ disorders and other intraoral and extraoral pains and disorders is described below.

Prior to use of the MRA 1, a dentist or a medical professional in the field of this art may inspect or analysis specific trigger points or hyperirritable areas that may be need relief based on the patient's pains and discomforts (i.e., palpating the tissue to locate the taut band or trigger point). In other instances, a patient “P” may be able to analyze specific trigger points or hyperirritable areas based on the pain or discomfort he or she is experiencing. If the mandible pain or discomfort can be relieved by intraoral ischemic compression therapy via the location of the trigger point, the head component 60 may be used in this situation.

If intraoral ischemic compression therapy is selected, the head component 60 may be selected and connected with the handle 10. Once the head component 60 connects with the handle 10, the head component 60 may contact and actuate the head sensor switch 42. Such actuation of the head sensor switch 42 may then send a first signal to the primary logic controller 40 to set the vibration motor 30 in a first mode or first set of parameters for generating mechanical energy.

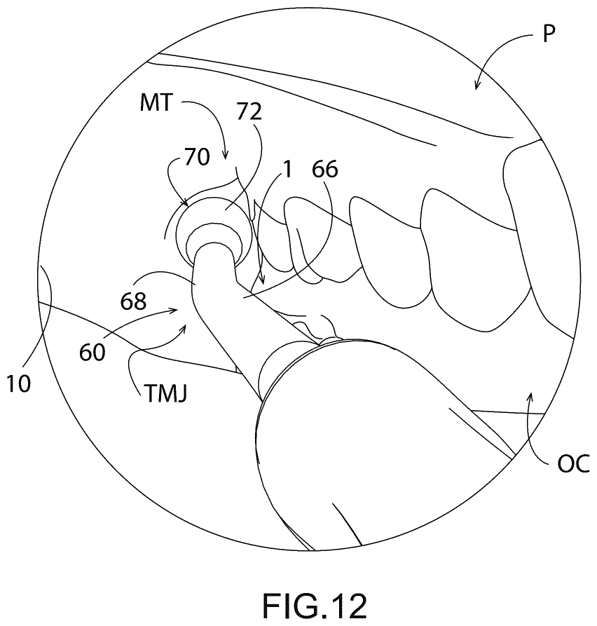

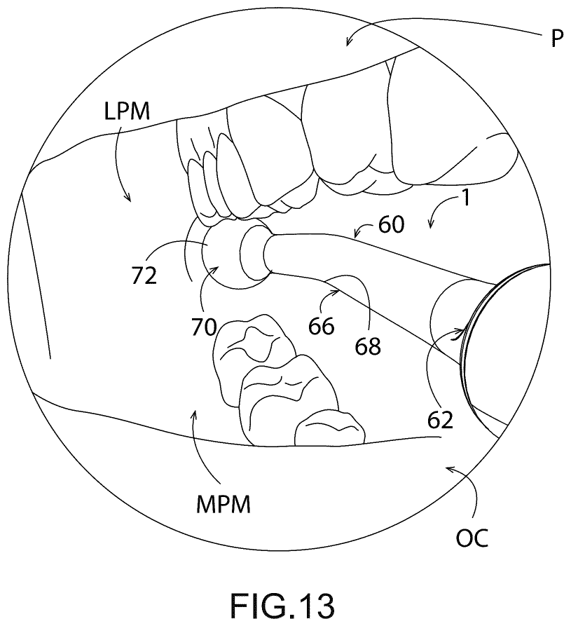

Once the head component 60 has been selected, the head component 60 may be inserted into a patient's oral cavity “OC” (see FIG. 12 and FIG. 13). As illustrated in FIG. 12, a user (either a dentist or patient) may insert the contact member 70 into the patient's oral cavity “OC” towards the patient's TMJ. Once the contact surface 72 of the contact member 70 is proximate to the TMJ and contacting surrounding muscle groups, the user may actuate the switch 41A from an OFF state to an ON state. Upon this actuation, the vibration motor 30 immediately creates vibrational waves that are transmitted to the driving vibration element 27J and out to the head component 60. During treatment, the user of the MRA 1 may maintain the contact member 70 at or near the location of the patient's TMJ for a predetermined amount of time until a suitable ischemic compression therapy is adequately performed. More particularly, the user may maintain the contact member 70 behind or posterior the patient's maxillary tuberosity “MT” to surrounding or proximate muscles for a predetermined amount of time until a suitable ischemic compression therapy is adequately performed. The head component 60 will continuously vibrate until the user actuates the switch 41A from the ON state to the OFF state. During this treatment time, the user may maintain pressure proximate to the patient's TMJ in which the contact member 70 is be pressed against muscle surrounding the patient's TMJ while applying vibrational waves via the vibration motor 30.

At the end of the predetermined amount of time for treatment, the user may then actuate switch 41A from the ON state to the OFF state to cease vibrational waves from the vibration motor 30. At this time, the user may then remove the head component 60 from the patient's oral cavity “OC” and complete the massage and manipulation.

However, the user may continue to apply treatment interior to the patient's oral cavity. As illustrated in FIG. 13, the MRA 1 may be used to massage and manipulate a patient's lateral pterygoid muscle “LPM”, a patient's medial pterygoid muscle “MPM”, and other surrounding muscle or tissue to stretch and loosen the muscle surrounding and/or attached to the TMJ. As illustrated in FIG. 13, the user may leave the contact member 70 of the MRA 1 at a specific trigger point or hyperirritable area (i.e., the lateral pterygoid muscle) for maximizing ischemic compression therapy at a localized area. In other instances, the user may move the contact member 70 of the MRA 1 inside of the patient's oral cavity for relieving multiple trigger points or hyperirritable areas along different muscle groups or connective tissue areas. For example, the user may begin treatment at the TMJ (see FIG. 12) for a predetermined amount of time and then later begin treatment at the lateral pterygoid muscle “LPM” (see FIG. 13) for another predetermined amount of time. Specifically, the user may apply ischemic pressure techniques such as rotating the contact member 70 into the lateral pterygoid muscle “LPM” and stroke vertically on the medial pterygoid muscle “MPM” as seen in FIG. 13. These processes of treatment may be repeated for maximizing stretching and unbinding of the muscle groups or connective tissues. While not illustrated herein, the user may move the contact member 70 of the MRA 1 to the opposing side of the patient's oral cavity for additional massaging and manipulation.

During intraoral treatment shown in FIGS. 12-13, the patient may slowly open and close his/her jaw bone to allow the contact member 70 to be pressed against the length of the muscle groups, specifically the lateral pterygoid muscle “LPM” and the medial pterygoid muscle “MPM”. Such movement of the patient's jaw bone while applying pressure and vibrational waves to the intraoral muscle groups may increase the ability for blood flow to increase in the contracted muscle groups. Such massaging and manipulation of the lateral pterygoid muscle “LPM” and the medial pterygoid muscle “MPM” may also allow the muscle groups to lengthen and regain their natural unconstructed length. Such massaging and manipulation of the lateral pterygoid muscle “LPM” and the medial pterygoid muscle “MPM” may also provide immediate improvement in ease of opening of the patient's jaws and increased range of motion while opening said jaws.

During this treatment, MRA 1 may provide substantially instant pain relief to the localized areas, particularly muscle groups proximate to the patient's TMJ inside said patient's oral cavity “OC”. In other words, the vibrating contact member 70 of MRA 1, via the vibration motor 30, is able to provide substantially instant pain relief to the localized areas such as muscles proximate to or surrounding the patient's maxillary tuberosity “MT”, the patient's lateral pterygoid muscle “LPM”, the patient's medial pterygoid muscle “MPM”, and any other muscle groups proximate to or near the patient's TMJ. As such, the vibrating contact member 70 may substantially relieve pain inside of the patient's oral cavity “OC” when applying MRA 1 to the muscle groups proximate to the patient's TMJ.

The head component 60 used with the handle 10 is considered advantageous at least because head component 60 allows a user to treat TMJ pain and discomfort inside of the patient's oral cavity via ischemic compression therapy. The design of the head component 60 allows a user to insert the head component 60 into the patient's oral cavity to direct apply ischemic compression therapy on the patient's TMJ and other surrounding muscle groups that may alleviate the patient's TMJ disorder, more particularly the lateral pterygoid muscle and the medial pterygoid muscle. Specifically, the bend 68 in the head component 60 and the flexible support member 66 allows a user to articulate the MRA 1 inside of the patient's oral cavity to directly contact the patient's TMJ with the contact member 70 or other muscle groups needing a myofascial release, more particularly the lateral pterygoid muscle. The design of the head component 60 also allows a user to avoid contacting or touching upper or lower teeth inside of the patient's oral cavity “OC”

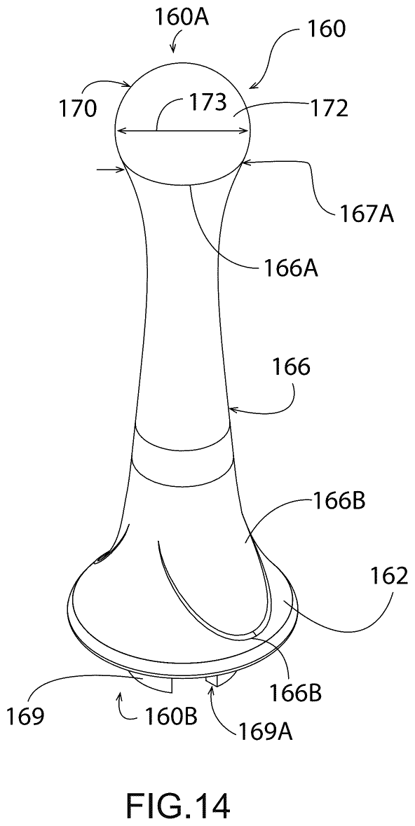

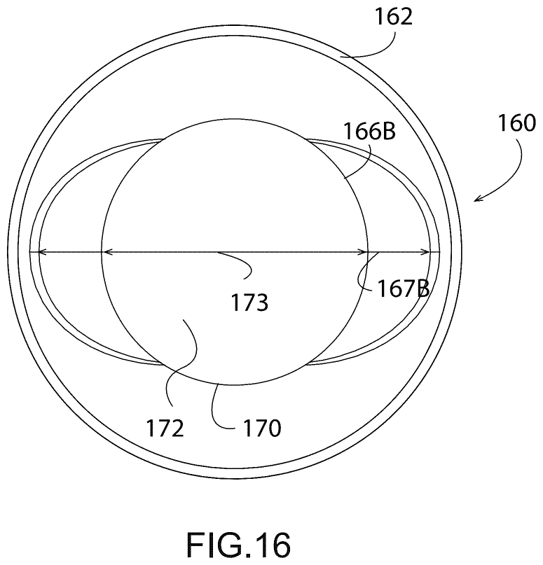

FIGS. 14-18 illustrate another head component 160 that is different than the head component 60 described above. The head component 160 may be used with the handle 10 for treatment purposes.

As illustrated in FIGS. 14-16, the head component 160 is operably engaged with the handle 10 and is operably connected with vibration motor 30 via the driving assembly substantially similar to the head component 60. The head component 160 is also configured to provide ischemic compression therapy to relieve pain and dysfunction interior to a patient's oral cavity specifically to a patient's masseter muscle, which is described in more detail below. More particularly, head component 160 may be configured to provide ischemic compression therapy to relieve pain and dysfunction interior to a patient's oral cavity, specifically the masseter muscle and the orbicularis oris muscle.

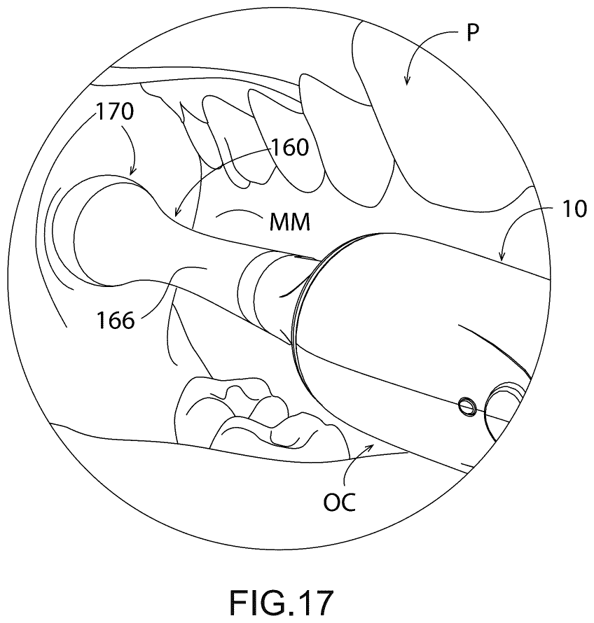

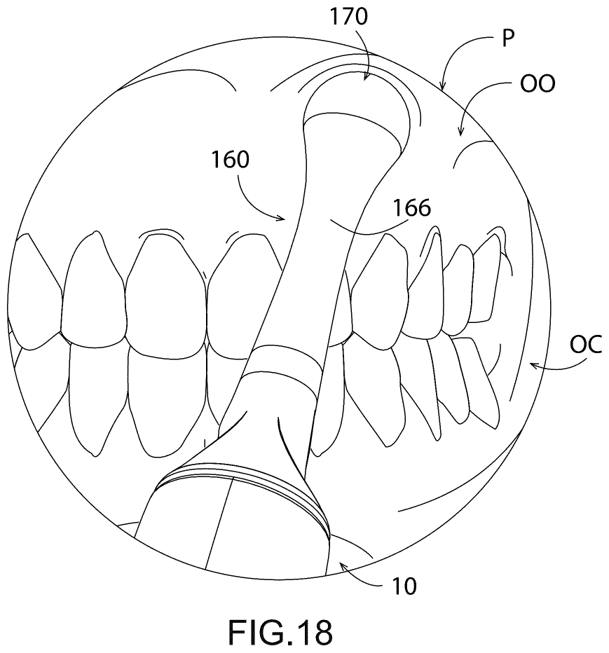

As illustrated in FIGS. 14-16, the head component 160 may include a first end or top end 160A, an opposing second end or bottom end 160B, and a length 160C that measures from the top end 160A to the bottom end 160B. In the illustrated embodiment, the length 160C of the head component is about sixty millimeters in length. In other exemplary embodiments, a head component may have any suitable length for providing intraoral and extraoral treatment in regards to TMJ disorder. The head component 160 may include a base member 162 proximate to the bottom end 160B of the head component 160. As illustrated in FIGS. 17-18, the base member 162 directly abuts a top end 11A of the case 11 when the head component 160 is provided on the handle 10. The base member 162 is also tapered from the bottom end 160B of the head component 160 towards the top end 160A of head component 160. Such taper of the base member 162 may allow for greater range of inserting the head component into a patient's oral cavity during an ischemic compression therapy for treating temporomandibular joint (TMJ) disorder (e.g., massaging the TMJ joint or muscles surrounding the TMJ joint).

Referring to FIG. 17-18, the head component 160 may include a receiving member (not illustrated) that extends from the bottom end 160B of the head component 160 towards the top end 160A of the head component 160. The receiving member is substantially similar to receiving member 64 of head component 60 where the head component 160 may interlockingly engage with the handle 10. Such engagement between head component 160 and the handle 10 allows for the head component 160 to receive the vibrational energy generated from the vibration motor 30 and the drive assembly 31 of the handle 10 to perform ischemic compression therapy to a trigger point or hyperirritable area of a patient that is interior to the patient's oral cavity.

Still referring to FIGS. 17-18, the head component 160 may include a support member 166 that extends from the base member 162 towards the top end 160A of the head component 160. The support member 166 may have a first end or upper end 166A proximate to the top end 160A of the head component 160 and an opposing second end or lower end 166B proximate to the base member 162. As illustrated in FIG. 4, the support member 166 defines a second length “L2” that extends from the upper end 166A to the lower end 166B. In the illustrated embodiment, the second length “L2” is equal to the first length “L1” of the support member 66 of the head component 60 described above. Such length of the head component 160 must be long enough to maneuver over the full width of the patient's masseter muscle to adequately perform ischemic compression therapy on said masseter muscle. Such treatment of the masseter muscle is described in more detail below.

The support member 166 also tapers from the lower end 166B to the upper end 166A where the support member 66 defines a first diameter 167A proximate to the upper end 166A and a second diameter 167B proximate to the lower end 166B; the second diameter 167B is greater than the first diameter 167A. Such taper of the support member 166 may allow for greater range of inserting the head component 160 into a patient's oral cavity during an ischemic compression therapy for treating TMJ disorder (e.g., massaging the TMJ joint or muscles surrounding the TMJ joint). In the illustrated embodiment, the support member 166 may have a taper that ranges from about two millimeters up to about five millimeters between the top and bottom ends 160A, 160B. Such increases in the taper of the support member 166 must be able to engage the patient's masseter muscle, which attaches into the patient's zygomatic arch, to adequately perform an ischemic compression therapy on said masseter muscle. Such treatment of the masseter muscle is described in more detail below.

Still referring to FIGS. 14-16, the support member 166 may be substantially straight between the upper end 166A and the lower end 166B as compared to support member 66 of the head component 60 described above. With this configuration, the support member 166 is more robust and less flexible as compared to the support member 66 of the head component 60 described above. The substantially straight configuration of the support member 166 may allow for greater range of inserting the head component 60 into a patient's oral cavity Moreover, the inclusion of the substantially straight configuration in the support member 166 may provide a greater amount of leverage of performing ischemic compression therapy at a specific trigger point or hyperirritable area interior to a patient's oral cavity, specifically the bulky masseter muscle inside of the patient's oral cavity.

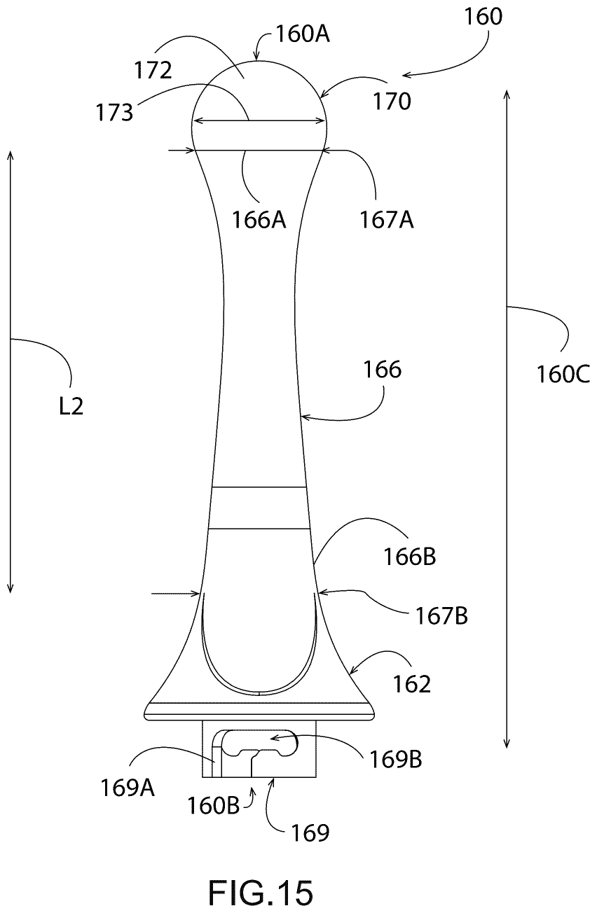

Head component 160 may include at least one attachment member 169 that operably engages with and/or interlockingly engages with the at least one engagement member 26. As best seen in FIGS. 14 and 15, head component 160 may include a single attachment member 169 that operably engages with the base member 162 and extends away from the base member 162 and the bottom end 160B. The attachment member 169 may define a first attachment opening 169A and a second attachment opening 169B. In the illustrated embodiment, the first attachment opening 169A and the second attachment opening 169B enables the first engagement member 26A and the second engagement member 26B to operably engage with the attachment member 169 for interlocking the head component 160 with the case 11. As such, the head component 160 is releasably secured with case 11 once the attachment member 169 interlocks with the first engagement member 26A and the second engagement member 26B.

Still referring to FIGS. 14-16, the head component 160 may also include a bulbous contact member 170. In the illustrated embodiment, the contact member 170 may be operably engaged with the support member 166, specifically at the upper end 166A of the support member 166. The contact member 170 may include a contact surface 172 positioned at the top end 160A of the head component. The contact member 170 define a bulbous or rounded shape where the contact surface 172 that is atraumatic. In other words, the contact member 170 is configured to prevent tissue damage or injury to a patient that is interior to the patient's oral cavity and/or exterior to the patient's oral cavity while performing an ischemic compression therapy. The contact member 170 is also aligned with the support member 166 and the base member 162 due to the substantially straight configuration of the support member 166.

Moreover, the contact member 170 may define a first material that is softer and/or more resilient than a second material that makes up the base member 162 and the support member 166. Any suitable soft or resilient medical grade material may be used for the contact member 170 to suitably provide myofascial massage or manipulation treatment while not injuring or damaging soft tissue, muscle, or bones interior to or exterior to a patient's oral cavity.

Still referring to FIG. 15, the contact member 170 may also define a third diameter 173. The third diameter 173 of the contact member 170 is greater than the first diameter 167A of the support member 166. Such difference in diameter between the contact member 170 and the upper end 166A of the support member 166 may allow for greater range of inserting the head component 160 into a patient's oral cavity during an ischemic compression therapy for treating (TMJ) disorder (e.g., massaging the masseter muscle inside of the patient's oral cavity). Moreover, the third diameter 173 of the head component 160 is greater than the third diameter 73 of the contact member 70 of the head component 60. In the illustrated embodiment, the third diameter 173 is about ten millimeters for the contact member 170. Such difference in the third diameter 73 of the contact member 70 allows the user to massage and manipulate the bulky masseter muscle inside of the patient's oral cavity.

Having now described the features and elements of head component 160, methods of using the head component 160 for treating TMJ disorders and other intraoral and extraoral pains and disorders is described below.

Prior to use of head component 160, a dentist or a medical professional in the field of this art may inspect or diagnosis specific trigger points or hyperirritable areas that may be need relief based on the patient's pains and discomforts (i.e., palpating the tissue to locate the taut band or trigger point). In other instances, a patient “P” may be able to analyze specific trigger points or hyperirritable areas based on the pain or discomfort he or she is experiencing. If the mandible pain or discomfort can be relieved by intraoral an ischemic compression therapy, the head component 160 may be used in this situation. Specifically, this head component 160 may be used to relieve pain and discomfort along the masseter muscle interior to a patient's oral cavity “OC”.

If intraoral ischemic compression therapy is selected, the head component 160 may be selected and connected with the handle 10. Once the head component 160 connects with the handle 10, the head component 160 may contact and actuate the head sensor switch 42. Such actuation of the head sensor switch 42 may then send a second signal to the primary logic controller 40 to set the vibration motor 30 in a second mode or second set of parameters for generating mechanical energy. It should be understood that the second signal sent to the primary logic controller 40 to set the vibration motor 30 to the second mode or second set of parameters for generating mechanical energy is different than the first signal sent to the primary logic controller 40 for setting the vibration motor 30 to the first mode or first set of parameters for generating mechanical energy when the head component 60 is selected.

Once the head component 160 has been selected, the head component 160 may be inserted into a patient's oral cavity “OC” (see FIG. 17). As illustrated in FIG. 17, a user (either a dentist or patient) may insert the contact member 170 into the patient's oral cavity “OC” towards the masseter muscle “MM” and other surrounding muscle or tissue to stretch and loosen the muscle surrounding and/or attached to the TMJ (e.g, lateral pterygoid muscle and medial pterygoid muscle). As illustrated in FIG. 17, the user may leave the contact member 170 at a trigger point or hyperirritable area on the masseter muscle “MM” for maximizing treatment at a localized area to stretch the masseter muscle “MM” outward from a patient's zygomatic arch to the patient's mandible attachment of the bone. In other instances, the user may move or sweep the contact member 170 along the width of the masseter muscle “MM” inside of the patient's oral cavity for relieving multiple trigger points or hyperirritable area along the masseter muscle “MM” and other adjacent muscle groups; particularly, to stretch the masseter muscle “MM” outward from a patient's zygomatic arch to the patient's mandible attachment of the bone. For example, the user may begin treatment near the TMJ for a predetermined amount of time and then later begin treatment at the masseter muscle “MM” for another predetermined amount of time. Specifically, the user may apply ischemic pressure techniques such as rotating the contact member 170 into the masseter muscle “MM” as seen in FIG. 17. These processes of treatment may be repeated for maximizing stretching and unbinding of the masseter muscle “MM” and other proximate muscle groups or connective tissues. While not illustrated herein, the user may move the contact member 170 to the opposing side of the patient's oral cavity for additional massaging and manipulation of the opposing masseter muscle.

As illustrated in FIG. 18, the user may insert the contact member 170 into the patient's oral cavity “OC” towards an orbicularis oris muscle “OO” and other surrounding muscle or tissue to stretch and loosen the orbicularis oris muscle “OO”. As illustrated in FIG. 18, the user may leave the contact member 170 at a trigger point or hyperirritable area on the orbicularis oris muscle “OO” for maximizing treatment at a localized area. In other instances, the user may move the contact member 170 along the width of the orbicularis oris muscle “OO” inside of the patient's oral cavity for relieving multiple trigger points or hyperirritable areas along the orbicularis oris muscle “OO” and other adjacent muscle groups. For example, the user may begin treatment above the patient's upper teeth for a predetermined amount of time and then later begin treatment below the patient's lower teeth for another predetermined amount of time. Specifically, the user may apply ischemic pressure techniques by sweeping the contact member 170 along orbicularis oris muscle “OO” as seen in FIG. 18. These processes of treatment may be repeated for maximizing stretching and unbinding of the orbicularis oris muscle “OO” and other proximate muscle groups or connective tissues. While not illustrated herein, the user may move the contact member 170 to the opposing lower end of the patient's oral cavity for additional massaging and manipulation of the opposing orbicularis oris muscle proximate the patient's lower teeth and lower lip.

During this treatment, head component 160 may provide substantially instant pain relief to the localized areas, particularly muscle groups proximate to the patient's TMJ inside said patient's oral cavity “OC”. In other words, the vibrating contact member 170, via the vibration motor (not illustrated), is able to provide substantially instant pain relief to the localized areas such as the patient's masseter muscle “MM” inside the patient's oral cavity “OC”, the patient's orbicularis oris muscle “OO” inside the patient's oral cavity “OC”, and any other muscle groups proximate to or near the patient's masseter muscle “MM” or orbicularis oris muscle “OO” inside the patient's oral cavity “OC”. As such, the vibrating contact member 170 may substantially relieve pain inside of the patient's oral cavity “OC” when applying head component 160 to the muscle groups proximate to the patient's masseter muscle “MM” and/or orbicularis oris muscle “OO”.

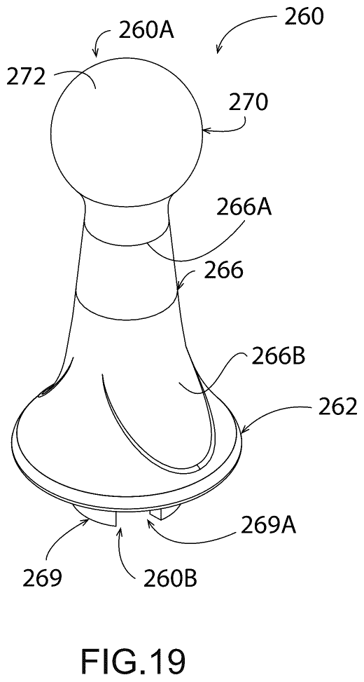

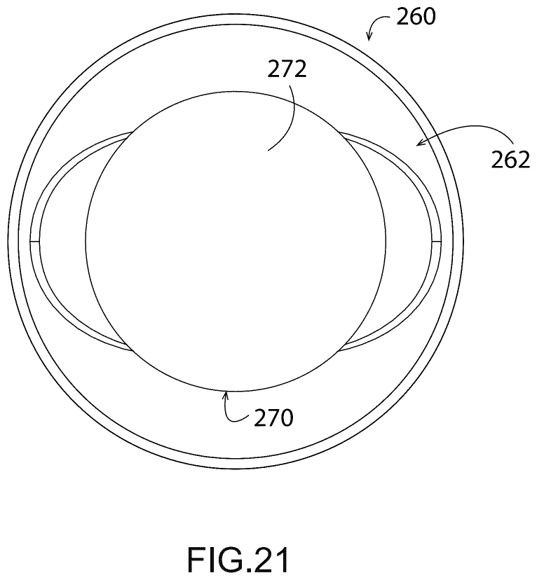

FIGS. 19-22D illustrate another head component 260 that is different than head components 60, 160 described above and configured to operably engage with the handle 10.

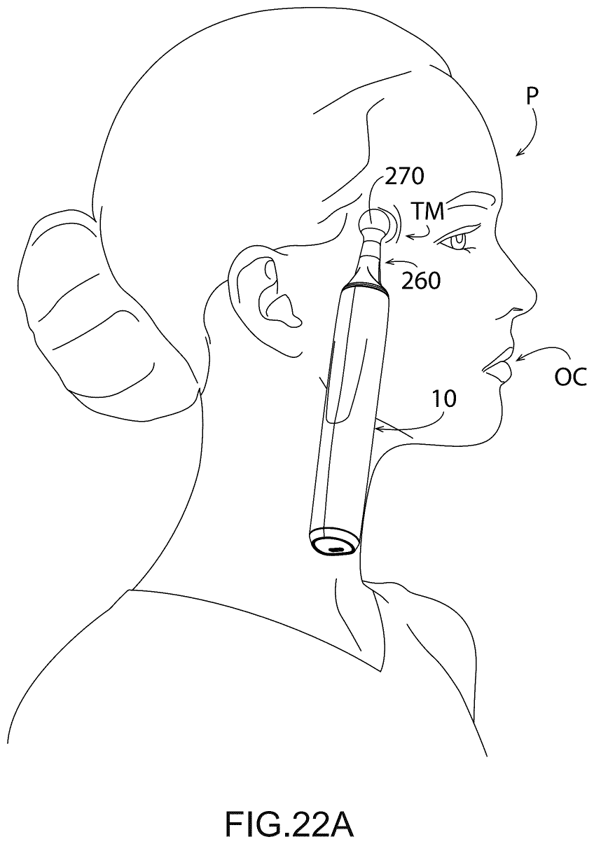

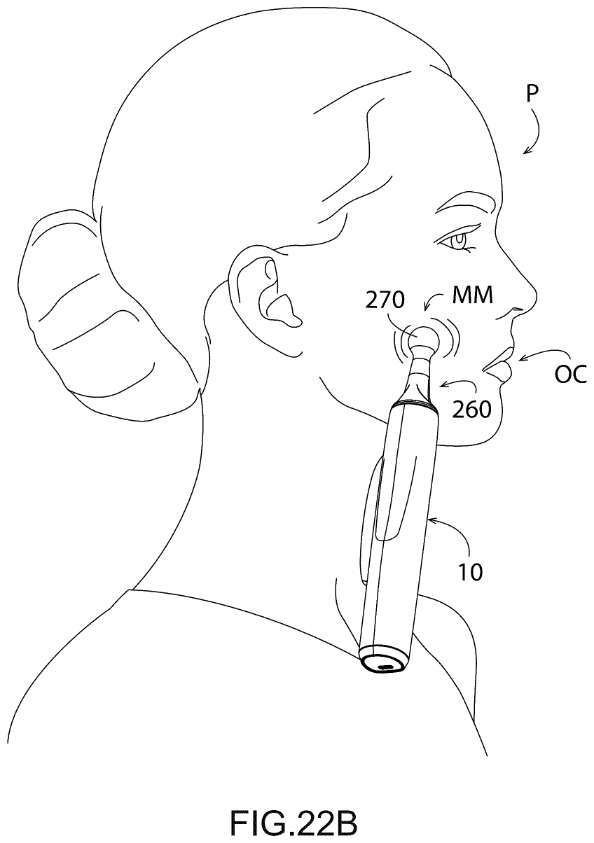

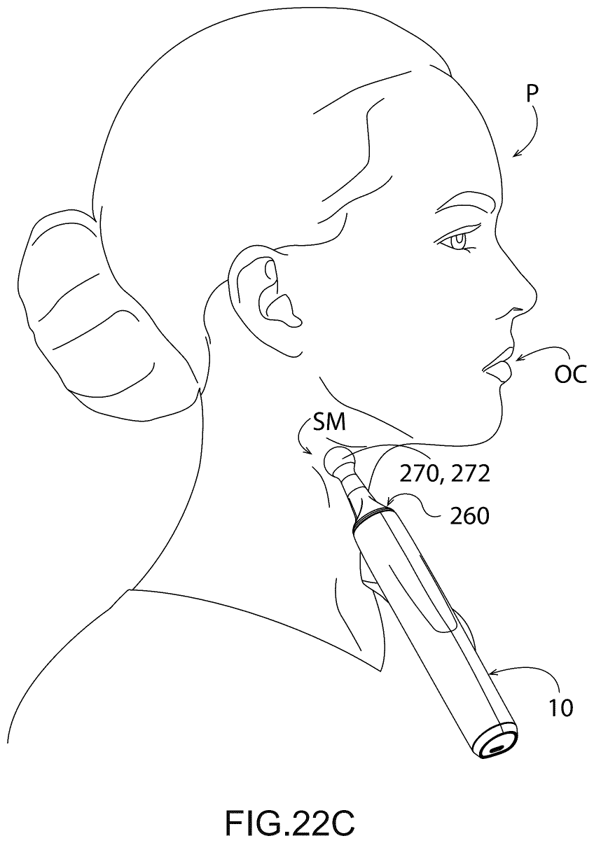

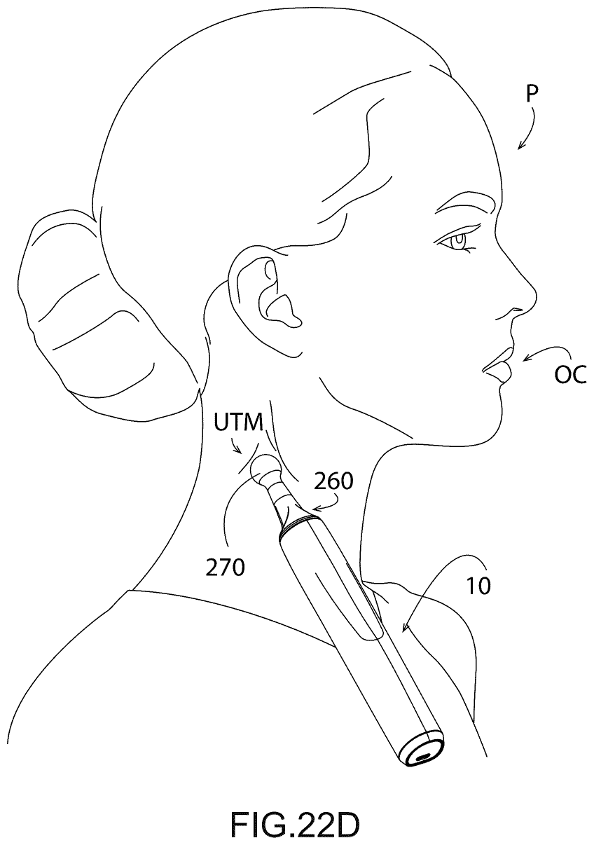

As illustrated in FIGS. 22A-22D, the head component 260 is operably engaged with the handle 10 and is operably connected with a vibration motor (not illustrated) substantially similar to the head component 260. The head component 260 is only configured to relieve pain and dysfunction exterior to an oral cavity including temporalis muscle, the lateral pterygoid muscle, the masseter muscle, the sternocleidomastoideole, and the trapezius muscle, which is described in more detail below. In this illustrated embodiment, head component 260 operably engages with the head sensor switch 42 and actuates the head sensor switch 42 to send at least one electrical signal to the primary controller 40. Such actuation by head component 260 may cause the primary controller 40 to set the vibration motor 30 to a predetermined setting, including increasing the rotational speed and/or mechanical energy generating by the vibration motor 30 compared to the rotational speed and/or mechanical energy generated by the vibration motor 30 when either head component 60 or head component 160 are used.

As illustrated in FIGS. 14-16, the head component 260 may include a first end or top end 260A, an opposing second end or bottom end 260B, and a length 260C that measures from the top end 260A to the bottom end 260B. In the illustrated embodiment, the length 260C of the head component is about thirty millimeters in length. In other exemplary embodiments, a head component may have any suitable length for providing intraoral and extraoral treatment in regards to TMJ disorder. The length 260C of the head component 260 is less than the lengths 60C, 160C of head components 60, 160. Such shorter length of the head component 260 provides additional strength and less flexibility as compared to head components 60, 160 in order to provide ischemic muscle release to the masseter muscle, the temporalis muscle, the sternocleidomastoideole, and the trapezius muscle. While the head components 60, 160 are suitable for extraoral treatment, the head component 260 is more suitable for applying ischemic compression therapy to the exterior muscles to relieve and eliminate TMJ disorder.

The head component 260 may include a base member 262 proximate to the bottom end 260B of the head component 260. As illustrated in FIGS. 22A-22D, the base member 262 directly abuts a top end 11A of the case 11 when the head component 260 is provided on the handle 10. The base member 262 is also tapered from the bottom end 260B of the head component 260 towards the top end 260A of head component 260.

Referring to FIG. 22A-22D, the head component 260 may include a receiving member (not illustrated) that extends from the bottom end 260B of the head component 260 towards the top end 260A of the head component 260. The receiving member is substantially similar to receiving member 64 of head component 60 where the head component 260 may interlockingly engage with the handle 10. Such engagement between head component 260 and the handle 10 allows for the head component 260 to receive the vibrational energy and/or waves generated by the vibration motor 30 and drive assembly 31 of the handle 10 to perform ischemic compression therapy to at least one trigger point of a patient that is exterior to the patient's oral cavity.

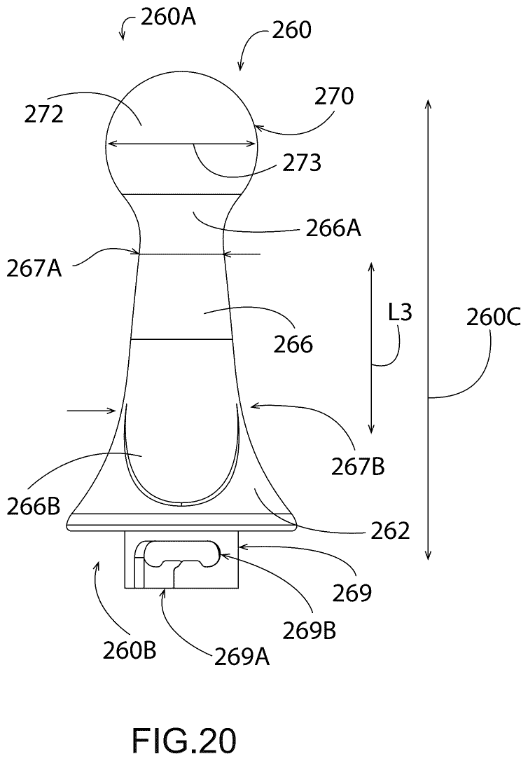

Referring to FIGS. 19-21, the head component 260 may include a support member 266 that extends from the base member 262 towards the top end 260A of the head component 260. The support member 266 may have a first end or upper end 266A proximate to the top end 260A of the head component 260 and an opposing second end or lower end 266B proximate to the base member 262. As illustrated in FIG. 20, the support member 166 defines a third length “L3” that extends from the upper end 166A to the lower end 166B. In the illustrated embodiment, the third length “L3” is less than the first length “L1” of the support member 66 of the head component 60 and the second length “L2” of the support member 166 of the head component 110 described above. Such shorter length of the head component 260 provides additional strength and less flexibility as compared to head components 60, 160 in order to provide ischemic compression therapy to the masseter muscle, the temporalis muscle, the sternocleidomastoideole, and the trapezius muscle. Such treatment of these muscle groups with the head component 260 is described in more detail below.

The support member 266 also tapers from the lower end 266B to the upper end 266A where the support member 266 defines a first diameter 267A proximate to the upper end 266A and a second diameter 267B proximate to the lower end 266B; the second diameter 267B is greater than the first diameter 267A. In the illustrated embodiment, the support member 266 may have a taper that ranges from about two millimeters up to about five millimeters between the top and bottom ends 160A, 160B. Such increases in the taper of the support member 166 must be able to engage the patient's masseter muscle, which attaches into the patient's zygomatic arch, to adequately perform an ischemic compression therapy on said masseter muscle. Such treatment of the masseter muscle is described in more detail below.

Still referring to FIG. 20, the support member 266 may be substantially straight between the upper end 266A and the lower end 266B as compared to support member 66 of the head component 60 described above. With this configuration, the support member 266 is more robust and less flexible as compared to the support member 66 of the head component 60 and the support member 166 and the head component 160 described above. The inclusion of the substantially straight configuration in the support member 366 may provide a greater amount force of leverage at a specific trigger point or hyperirritable area exterior to a patient's oral cavity, specifically the masseter muscle and other exterior muscles such as the temporalis muscle, the sternocleidomastoideole, and the trapezius muscle.

Head component 260 may include at least one attachment member 269 that operably engages with and/or interlockingly engages with the at least one engagement member 26. As best seen in FIGS. 18 and 19, head component 260 may include a single attachment member 269 operably engages with the base member 262 and extends away from the base member 262 and the bottom end 260B. The attachment member 269 may define a first attachment opening 269A and a second attachment opening 269B. In the illustrated embodiment, the first attachment opening 269A and the second attachment opening 269B enables the first engagement member 26A and the second engagement member 26B to operably engage with the attachment member 269 for interlocking the head component 260 with the case 11. As such, the head component 260 is releasably secured with case 11 once the attachment member 269 interlocks with the first engagement member 26A and the second engagement member 26B. While not illustrated herein, attachment member 269 may actuate the head sensor switch 42 to cause the vibration motor 30, via the primary controller 40, to increase the rotational speed and/or mechanical energy generated by the vibration motor 30 when treating larger muscle groups.

Still referring to FIGS. 19-21, the head component 260 may also include a bulbous contact member 270. In the illustrated embodiment, the contact member 270 may be operably engaged with the support member 266, specifically at the upper end 266A of the support member 266. The contact member 270 may include a contact surface 272 positioned at the top end 260A of the head component. The contact member 270 and the contact surface 272 define a bulbous or rounded shape that is atraumatic. In other words, the contact member 270 and the contact surface 272 are configured to prevent tissue damage or injury to a patient that is interior to the patient's oral cavity and/or exterior to the patient's oral cavity while performing ischemic compression therapy or manipulation treatment. The contact member 270 is also aligned with the support member 266 and the base member 262 due to the substantially straight configuration of the support member 266.

Moreover, the contact member 270 may define a first material that is softer and/or more resilient than a second material that makes up the base member 262 and the support member 266. Any suitable soft or resilient medical grade material may be used for the contact member 270 to suitably provide myofascial massage or manipulation treatment while not injuring or damaging soft tissue, muscle, or bones interior to or exterior to a patient's oral cavity.

Still referring to FIG. 20, the contact member 270 may also define a third diameter 273. The third diameter 273 of the contact member 270 is greater than the first diameter 267A of the support member 266. Moreover, the third diameter 273 is greater than the third diameter 73 of the contact member 70 of the head component 60 and the third diameter 173 of the contact member 170 of the head component 160. In the illustrated embodiment, the third diameter 273 is about fifteen millimeters for the contact member 270. Such difference in the third diameter 73 of the contact member 70 and third diameter 173 of the contact member 70 from the third diameter 279 of the contact member 270 allows the user to massage and manipulate the bulky masseter muscle and other exterior muscles such as the temporalis muscle, the sternocleidomastoideole, and the trapezius muscle exterior to the patient's oral cavity.

Having now described the features and characteristics of head component 260, methods of using the head component 260 for treating TMJ disorders and other extraoral pains and disorders is described below.

Prior to use of the MRA 200, a dentist or a medical professional in the field of this art may inspect or diagnosis specific trigger points or hyperirritable areas that may be need relief based on the patient's pains and discomforts (i.e., palpating the tissue to locate the taut band or trigger point). In other instances, a patient “P” may be able to analyze specific trigger points or hyperirritable areas based on the pain or discomfort he or she is experiencing. If the mandible pain or discomfort can be relieved by extraoral ischemic compression therapy and manipulation, the head component 260 may be used in this situation. Specifically, this head component 260 may be used to relieve pain and discomfort along the masseter muscle exterior to a patient's oral cavity “OC”.

Once the intraoral treatment is complete or intraoral treatment was not needed based on the head components 60, 160, the head component 260 may be selected and connected with the handle 10. Once the head component 260 connects with the handle 10, the head component 260 may contact and actuate the head sensor switch 42. Such actuation of the head sensor switch 42 may then send a third signal to the primary logic controller 40 to set the vibration motor 30 in a third mode or third set of parameters for generating mechanical energy. It should be understood that the third signal sent to the primary logic controller 40 to set the vibration motor 30 to the third mode or third set of parameters for generating mechanical energy is different than the first and second signals sent to the primary logic controller 40 to set the vibration motor 30 to the first and second modes or first and second sets of parameters for generating mechanical energy when either head component 60, 160 are selected.

Once the head component 260 has been selected, the head component 260 may be placed on a patient exterior to said patient's oral cavity “OC” (see FIGS. 22A-22D). As illustrated in FIG. 22B, a user (either a dentist or patient) may place the contact member 270 on to the patient's head proximate to the patient's masseter muscle “MM”. Once the contact surface 272 of the contact member 270 is in contact with or proximate to the patient's masseter muscle “MM”, the user may actuate the switch from an OFF state to an ON state. Upon this actuation, the vibration motor 30 immediately creates vibrational waves, via the drive assembly 31, that are transmitted to the driving vibration element 27J and out to the head component 260. During treatment, the user of the head component 260 may maintain the contact member 270 at or near the location of the patient's masseter muscle “MM” for a predetermined amount of time until a suitable myofascial ischemic compression therapy is adequately performed (i.e., stretching and releasing tension in the masseter muscle “MM”). The head component 260 will continuously vibrate until the user actuates the switch from the ON state to the OFF state.

Furthermore, the user may continue extraoral treatment on the patient with the head component 260 to muscle groups vertically below the patient's oral cavity. Specifically, the user may treat the temporalis muscle “TM” (see FIG. 22A) extraorally along with treatment to the sternocleidomastoideole “SM” (see FIG. 22C) and the upper trapezius muscle “UTM” (see FIG. 22D). Such extraoral myofascial release by the MRA 200 to these muscles groups illustrated in FIGS. 22A-22D may allow the muscle groups to lengthen and ultimately return to original length. Such lengthening of these muscle groups provides the patient with a greater range of motion when moving his/her jaw between an open position and a closed position (i.e., full range of motion for the patient's jaw bone).

During this treatment, head component 260 may provide substantially instant pain relief to the localized areas, particularly muscle groups proximate to the patient's TMJ exterior to said patient's oral cavity “OC”. In other words, the vibrating contact member 270, via the vibration motor 30 and the driving assembly 31, is able to provide substantially instant pain relief to the localized areas such as the patient's masseter muscle “MM” exterior to the patient's oral cavity “OC”, the patient's sternocleidomastoideole “SM”, the patient's the temporalis muscle “TM”, the patient's upper trapezius muscle “UTM”, and any other muscle groups exterior to the patient's oral cavity “OC” that are interconnected with the patient's TMJ. As such, the vibrating contact member 270 may substantially relieve pain exterior to the patient's oral cavity “OC” when applying head component 260 to the muscle groups proximate to the patient's sternocleidomastoideole “SM”, the patient's the temporalis muscle “TM”, and the patient's upper trapezius muscle “UTM”.

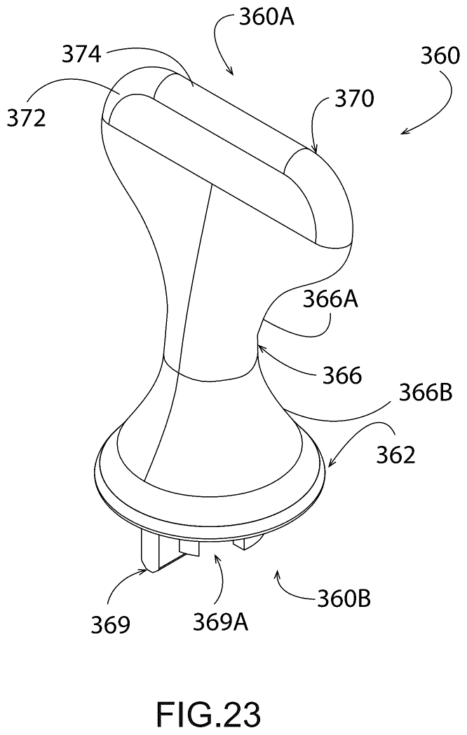

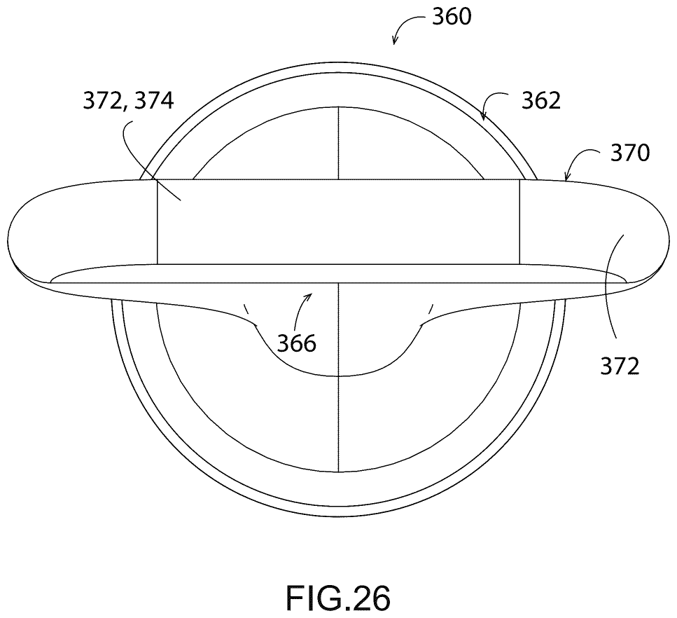

FIGS. 23-27D illustrate another head component 360 that is different than head components 60, 160, 260 as described above and configured to operably engage with the handle 10.

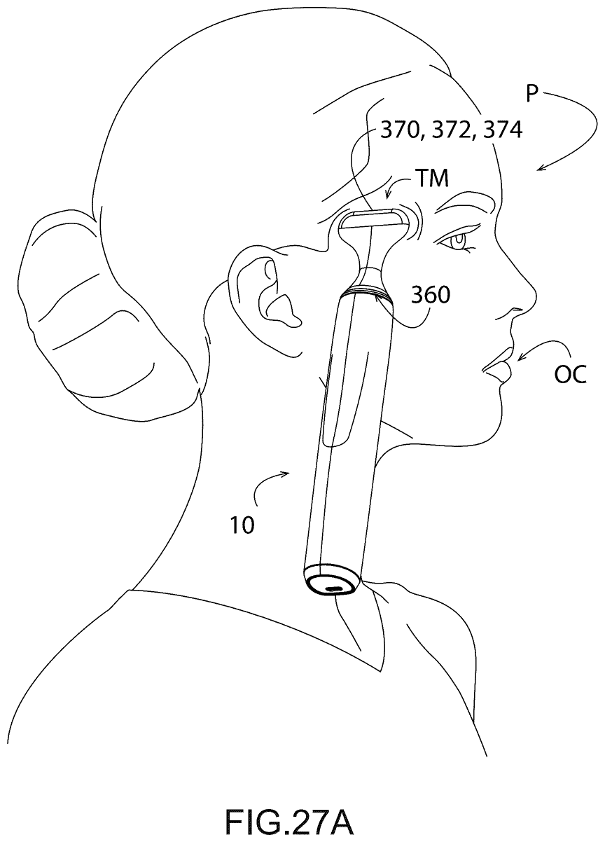

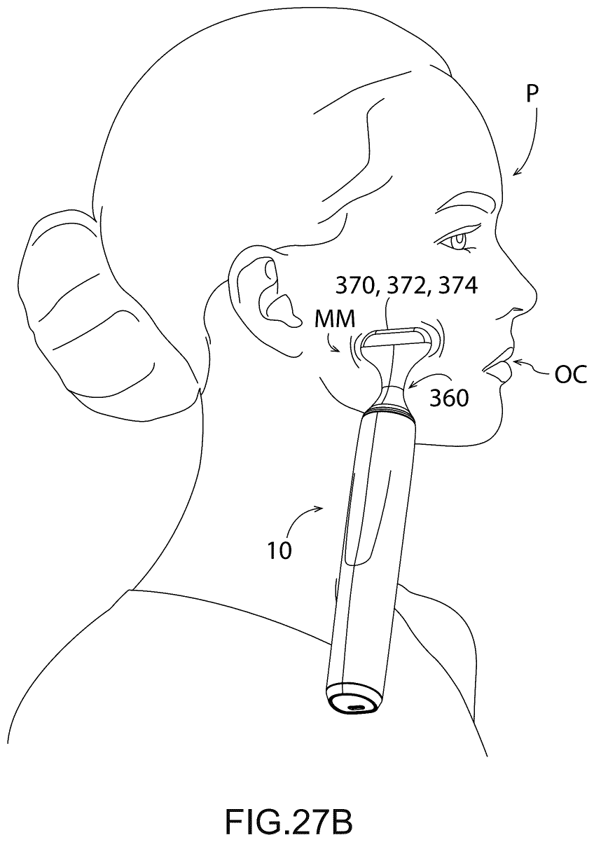

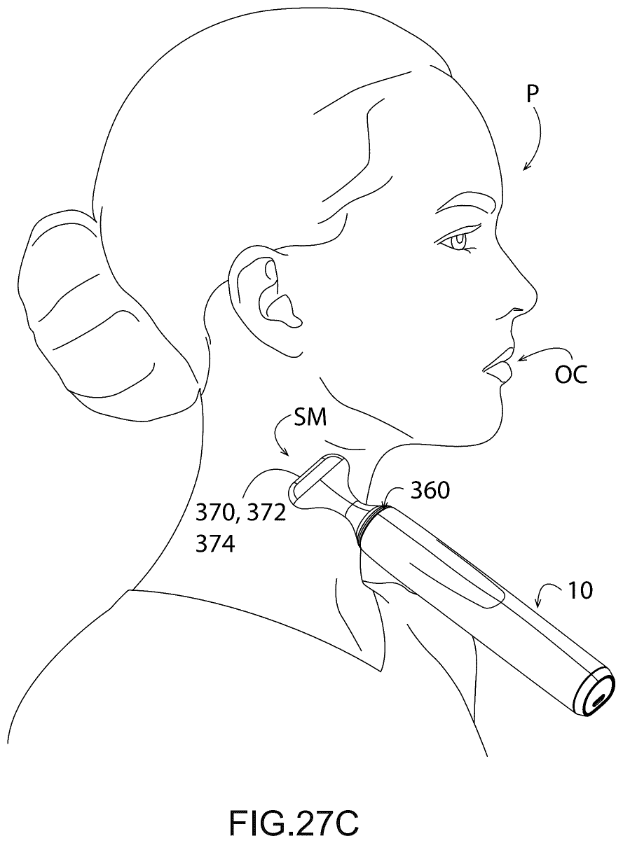

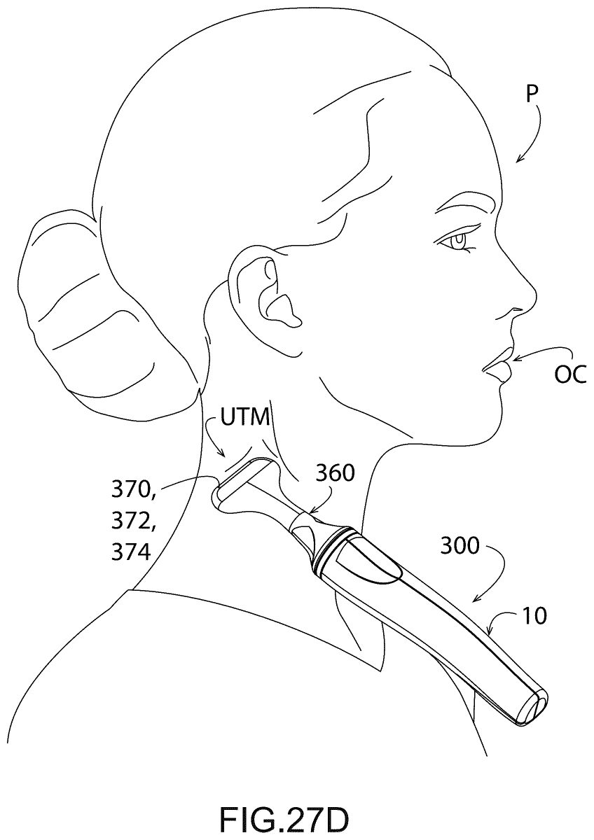

As illustrated in FIGS. 27A-27D, the head component 360 is operably engaged with the handle 10 and is operably connected with the vibration motor 30 and drive assembly 31 substantially similar to the head component 360. The head component 360 is only configured to relieve pain and dysfunction to muscles exterior to an oral cavity including temporalis muscle, the lateral pterygoid muscle, the masseter muscle, the sternocleidomastoideole, the trapezius muscle, and other surrounding exterior muscle groups. Moreover, the head component 360 is configured to be used in a scratching or scraping motion to provide a myofascial release along the temporalis muscle, the lateral pterygoid muscle, the masseter muscle, the sternocleidomastoideole, the trapezius muscle, and other surrounding exterior muscle groups. In other words, the head component 360 provides a release mechanism to relieve fascia stiffness in the exterior muscles described above. As such, the head component 360 is configured to apply a scraping pressure perpendicular to the external muscles listed above. By applying this myofascial release, the external muscles may regain full range of motion by removing restrictive function of the external functions provided by the external muscles.

As illustrated in FIGS. 22-24, the head component 360 may include a first end or top end 360A, an opposing second end or bottom end 360B, and a length 360C that measures from the top end 360A to the bottom end 360B. In the illustrated embodiment, the length 360C of the head component is about thirty millimeters in length. In other exemplary embodiments, a head component may have any suitable length for providing extraoral myofascial release treatment in regards to TMJ disorder. Such shorter length of the head component 360 provides additional strength and less flexibility as compared to head components 60, 160 in order to provide myofascial release to the masseter muscle, the temporalis muscle, the sternocleidomastoideole, and the trapezius muscle. Such treatment of these muscle groups with the head component 360 is described in more detail below.

In this illustrated embodiment, head component 460 also operably engages with the head sensor switch 42 and actuates the head sensor switch 42 to send at least another electrical signal to the primary controller 40. Such actuation by head component 360 may cause the primary controller 40 to set the vibration motor 30 to a predetermined setting, including increasing the rotational speed and/or mechanical energy generating by the vibration motor 30 compared to the rotational speed and/or mechanical energy generated by the vibration motor 30 when either head component 60 or head component 160 are used.

The head component 360 may include a base member 362 proximate to the bottom end 360B of the head component 360. As illustrated in FIGS. 27A-27D, the base member 362 directly abuts a top end 11A of the case 11 when the head component 360 is provided on the handle 10. The base member 362 is also tapered from the bottom end 360B of the head component 360 towards the top end 360A of head component 360.

Referring to FIG. 27A-27D, the head component 360 may include a receiving member (not illustrated) that extends from the bottom end 360B of the head component 360 towards the top end 360A of the head component 360. The receiving member is substantially similar to receiving member 64 of head component 60 where the head component 360 may interlockingly engage with the handle 10. Such engagement between head component 360 and the handle 10 allows for the head component 360 to receive the vibrational energy generated by the vibration motor 30 and drive assembly 31 of the handle 10 to perform myofascial massaging and relief to a trigger point or hyperirritable area of a patient that is exterior to the patient's oral cavity.

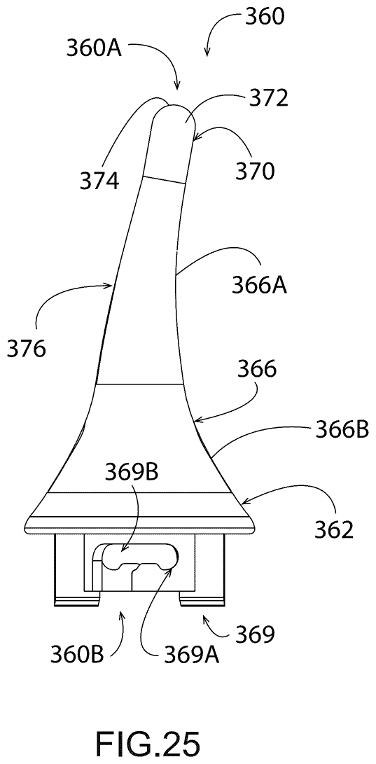

Referring to FIGS. 23-26, the head component 360 may include a support member 366 that extends from the base member 362 towards the top end 360A of the head component 360. The support member 366 may have a first end or upper end 366A proximate to the top end 360A of the head component 360 and an opposing second end or lower end 366B proximate to the base member 362. As illustrated in FIG. 25, the support member 166 defines a fourth length “L4” that extends from the upper end 166A to the lower end 166B. In the illustrated embodiment, the fourth length “L4” is less than the first length “L1” of the support member 66 of the head component 60 and the second length “L2” of the support member 166 of the head component 110 described above. Such shorter length of the head component 360 provides additional strength and less flexibility as compared to head components 60, 160 in order to provide myofascial release to the masseter muscle, the temporalis muscle, the sternocleidomastoideole, the trapezius muscle, and other surrounding exterior muscles to relieve the patient's TMJ. Such treatment of these muscle groups with the head component 360 is described in more detail below.

The support member 366 also tapers from the lower end 366B to the upper end 366A where the support member 366 defines a first diameter 367A proximate to the upper end 366A and a second diameter 367B proximate to the lower end 366B; the second diameter 367B is greater than the first diameter 367A.

Referring to FIG. 25, the support member 366 may also define a curve or bend 368 that is defined between the upper and lower ends 366A, 366B. The bend 368 of the support member 366 offsets the upper end and the lower ends 366A, 366B. In the illustrated embodiment, the upper end 366A is positioned forwardly of the lower end 366B due to the inclusion of the bend 368. In other exemplary embodiments, a bend of a support member may be defined at any suitable angle relative to a longitudinal axis of a head component based on various considerations. The inclusion of the bend 368 in the support member 366 may provide a greater amount force of leverage at a specific trigger point or hyperirritable area for adequately applying a myofascial release to specific external muscle groups listed herein.

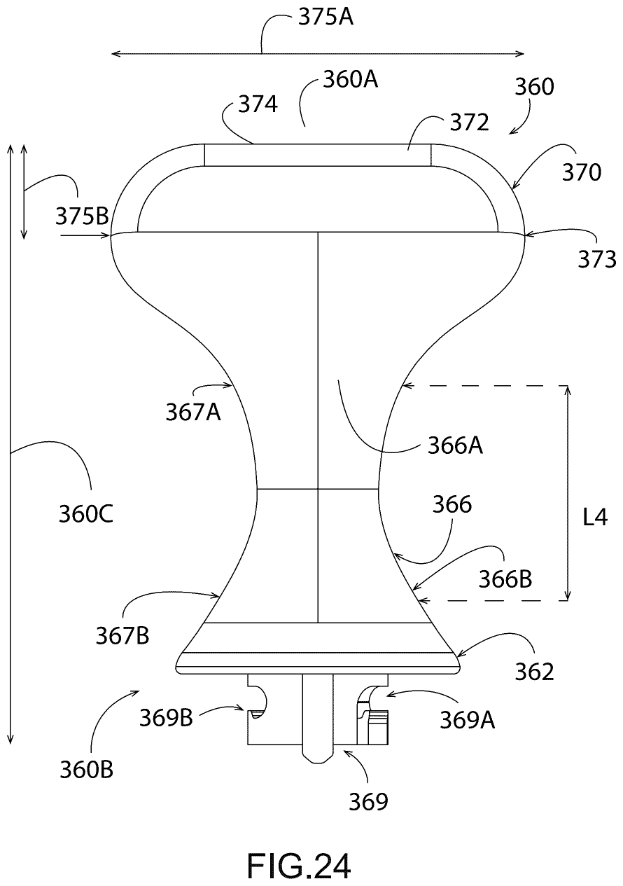

Head component 360 may include at least one attachment member 369 that operably engages with and/or interlockingly engages with the at least one engagement member 26. As best seen in FIGS. 23 and 24, head component 360 may include a single attachment member 369 that operably engages with the base member 362 and extends away from the base member 362 and the bottom end 360B. The attachment member 369 may define a first attachment opening 369A and a second attachment opening 369B. In the illustrated embodiment, the first attachment opening 369A and the second attachment opening 369B enables the first engagement member 26A and the second engagement member 26B to operably engage with the attachment member 369 for interlocking the head component 360 with the case 11. As such, the head component 360 is releasably secured with case 11 once the attachment member 369 interlocks with the first engagement member 26A and the second engagement member 26B. While not illustrated herein, attachment member 369 may actuate the head sensor switch 42 to cause the vibration motor 30, via the primary controller 40, to increase the rotational speed and/or mechanical energy generated by the vibration motor 30 when treating larger muscle groups.

Still referring to FIGS. 23-26, the head component 360 may also include a blade-shaped contact member 370. In the illustrated embodiment, the contact member 370 may be operably engaged with the support member 366, specifically at the upper end 366A of the support member 366. The contact member 370 may include a contact surface 372 positioned at the top end 360A of the head component 360. The contact member 370 and the contact surface 372 collectively define a blade-like, trapezoidal-shape or triangular-shape portion where a leading edge 374 of the contact member 370 is atraumatic. In other words, the contact member 370 is configured to prevent tissue damage or injury to a patient exterior to the patient's oral cavity while performing a myofascial massage or manipulation treatment. The contact member 370 is offset from the support member 366 and the base member 362 due to the bend 368 of the support member 366. As such, the contact member 370 is positioned forwardly of a portion of the support member 366 and the base member 362.

Moreover, the contact member 370 may define a first material that is softer and/or more resilient than a second material that makes up the base member 362 and the support member 366. Any suitable soft or resilient medical grade material may be used for the contact member 370 to suitably provide myofascial massage or manipulation treatment while not injuring or damaging soft tissue, muscle, or bones interior to or exterior to a patient's oral cavity.

Still referring to FIG. 24, the contact member 370 may also define a width 375A and a height 375B. The width 375A of the contact member 370 is greater than the first diameter 367A of the support member 366. Moreover, the width 375A of the contact member 370 is greater than the third diameter 73 of the contact member 70 of the head component 60, the third diameter 173 of the contact member 170 of the head component 160, and the third diameter 273 of the contact member 270. In the illustrated embodiment, the width 375A is about forty millimeters for the contact member 370. In addition, the height 375B measured between the upper end 366A of the support member 366 to the top end 366A of the head component 360 is about twenty millimeters. The larger width 375A of the contact member 370 and height 375B of the contact member 370 allows the user to apply a scrapping myofascial release to the bulky masseter muscle, the temporalis muscle, the sternocleidomastoideole, and the trapezius muscle exterior to the patient's oral cavity.

Having now described the features and characteristics of head component 360, methods of using head component 360 for treating TMJ disorders and extraoral pains and disorders are described below.

Prior to use of the head component 360, a dentist or a medical professional in the field of this art may inspect or diagnosis specific trigger points or hyperirritable areas that may be need relief based on the patient's pains and discomforts. In other instances, a patient may be able to analyze specific trigger points or hyperirritable areas based on the pain or discomfort he or she is experiencing. If the mandible pain or discomfort can be relieved by extraoral myofascial massaging and manipulation, the head component 360 may be used in this situation. Specifically, this head component 360 may be used to relieve pain and discomfort via myofascial release along the masseter muscle, the temporalis muscle, the sternocleidomastoideole, the trapezius muscle, and other surrounding muscle groups exterior to the patient's oral cavity.

Once the intraoral treatment is complete or intraoral treatment was not needed based on the head components 60, 160, the head component 360 may be selected and connected with the handle 10. Once the head component 360 connects with the handle 10, the head component 360 may contact and actuate the head sensor switch 42. Such actuation of the head sensor switch 42 may then send a fourth signal to the primary logic controller 40 to set the vibration motor 30 in a fourth mode or fourth set of parameters for generating mechanical energy. It should be understood that the fourth signal sent to the primary logic controller 40 to set the vibration motor 30 to the fourth mode or fourth set of parameters for generating mechanical energy is different than the first, second, and third signals sent to the primary logic controller 40 to set the vibration motor 30 to the first, second, and third modes or first, second, and third sets of parameters for generating mechanical energy when any head component 60, 160, 260 is selected.

Once the head component 260 has been selected, the head component 260 may be placed on a patient exterior to said patient's oral cavity “OC” (see FIGS. 27A-27D). As illustrated in FIG. 27A, a user (either a dentist or patient) may place the contact member 370 on to the patient's head proximate to the patient's temporalis muscle “TM”. Once the contact surface 372 of the contact member 370 is in contact with or proximate to the patient's temporalis muscle “TM”, the user may actuate the switch from an OFF state to an ON state. Upon this actuation, the vibration motor 30 and drive assembly 31 immediately creates vibrational energy and/or waves that are transmitted to the driving vibration element and out to the head component 360. During treatment, the user may move and/or scrape the contact member 370 at or near the location of the patient's temporalis muscle “TM” for a predetermined amount of time until a suitable myofascial massage and/or manipulation is adequately performed (i.e., stretching and releasing tension in the temporalis muscle). The head component 360 will continuously vibrate until the user actuates the switch from the ON state to the OFF state.

The user may continue extraoral treatment on the patient with head component 360 to muscle groups vertically below the patient's oral cavity. Specifically, the user may treat the masseter muscle “MM” (see FIG. 27B) extraorally along with treatment to the sternocleidomastoideole “SM” (see FIG. 27C) and the upper trapezius muscle “UTM” (see FIG. 27D) substantially similar to the treatment provided on the patient's temporalis muscle “TM” in FIG. 27A. Such extraoral myofascial release by the head component 360 to these muscles groups illustrated in FIGS. 27B-27D may allow the muscle groups to lengthen and ultimately return to original length. Such lengthening of these muscle groups provides the patient with a greater range of motion when moving his/her jaw between an open position and a closed position (i.e., full range of motion for the patient's jaw bone).

During this treatment, head component 360 may provide substantially instant pain relief to the localized areas, particularly muscle groups proximate to the patient's TMJ exterior to said patient's oral cavity “OC”. In other words, the vibrating contact member 370, via the vibration motor (not illustrated), is able to provide substantially instant pain relief to the localized areas such as the patient's masseter muscle “MM” exterior to the patient's oral cavity “OC”, the patient's sternocleidomastoideole “SM”, the patient's the temporalis muscle “TM”, the patient's upper trapezius muscle “UTM”, and any other muscle groups exterior to the patient's oral cavity “OC” that are interconnected with the patient's TMJ. As such, the vibrating contact member 370 may substantially relieve pain exterior to the patient's oral cavity “OC” when applying head component 360 to the muscle groups proximate to the patient's sternocleidomastoideole “SM”, the patient's the temporalis muscle “TM”, and the patient's upper trapezius muscle “UTM”.

As described previously, each head component 60, 160, 260, 360 may be configured to set a predetermined amount of vibration and frequency created by the handle 10 based on the configuration of each head component 60, 160, 260, 360 when attached to said handle 10. In other words, each head component 60, 160, 260, 360 may actuate or trigger a specific switch or relay (i.e., head sensor switch 42) on the handle 10 so that handle 10 creates a predetermined amount of vibration and frequency for each head component 60, 160, 260, 360. In one exemplary embodiment, a first head component, such as head component 60, would activate a first switch or relay on a handle, such as handle 10, causing the handle to create a first amount of vibration and frequency on the first head component. In another exemplary embodiment, a second head component, such as head component 160, would activate a second different switch or relay on a handle causing the handle to create a second amount of vibration and frequency on the second head component; the second amount of vibration and frequency is different than the first amount of vibration and frequency. In another exemplary embodiment, a third head component, such as head component 260, would activate a third different switch or relay on a handle causing the handle to create a third amount of vibration and frequency on the second head component; the third amount of vibration and frequency is different than the first and second amounts of vibration and frequency. In another exemplary embodiment, a fourth head component, such as head component 360, would activate a fourth different switch or relay on a handle causing the handle to create a fourth amount of vibration and frequency on the second head component; the fourth amount of vibration and frequency is different than the first, second, and third amounts of vibration and frequency. As such, each predetermined amount of vibration and frequency created by the handle 10 based on the head component 60, 160, 260, 360 may be different from one another based on the different uses of each head component 60, 160, 260, 360.

While not illustrated herein, a MRA provided herein may be configured to provide a variable rate frequency to vary the rate at which a respective head component would vibrate to provide treatment on a patient. In one exemplary embodiment, a vibration motor of a MRA may be adapted to produce varying vibration frequencies to a respective head component for various scenarios as determined by a user of the MRA, including whether the treatment is intraoral or extraoral, what type of muscle is being treated, what amount of pain is the patient experiencing, and other suitable scenarios for vary the vibration rate of the MRA.

While not illustrated herein, a pressure sensor may be operatively connected with a logic controller (such as logic controller 40) of an MRA to indicate whether the user of an MRA is apply a suitable amount of pressure when a specific head component (such as head components 60, 160, 260, 360) is attached to a handle (such as handle 10). In one exemplary embodiment, a pressure sensor may be operatively connected with a first indicator (e.g., a light or sound device) to indicate or announce that a user is applying an inadequate or insufficient amount of force on a handle of a MRA when a specific head component is operably engaged with said handle. In another exemplary embodiment, a pressure sensor may be operatively connected with a second indicator (e.g., a light or sound device) to indicate or announce that a user is applying too much or an excessive amount of force on a handle of a MRA when a specific head component is operably engaged with said handle. In another exemplary embodiment, a pressure sensor may also be operatively connected with a third indicator (e.g., a light or vibrational device) to indicator or announce that a user is applying an adequate or sufficient amount of force on a handle of a MRA when a specific head component is operably engaged with said handle.

While not illustrated herein, any one of the head components 60, 160, 260, 360 that is operably engaged with the handle 10 may provide treatment to a patient's or user's suboccipital muscles or muscles provided at the base the skull. In one exemplary embodiment, head component 260 may be used extraorally on the patient or user to provide treatment to the suboccipital muscles or muscles provided at the base the skull. In this particular embodiment, similar methods of treatment described and illustrated herein with head component 260 may be used to provide myofascial release of trigger points or hyperirritable areas at or near the suboccipital muscles. In another exemplary embodiment, head component 360 may be used extraorally on the patient or user to provide treatment to the suboccipital muscles or muscles provided at the base the skull. In this particular embodiment, similar methods of treatment described and illustrated with head component 360 herein may be used to provide myofascial release of trigger points or hyperirritable areas at or near the suboccipital muscles.

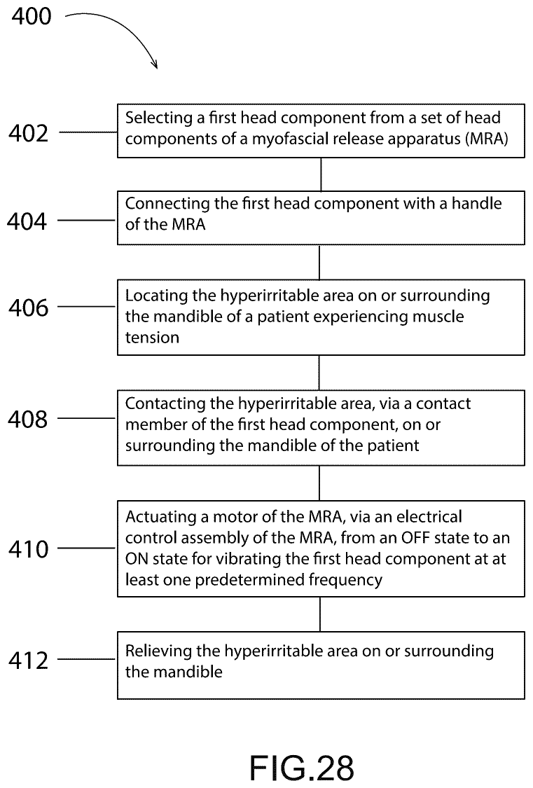

FIG. 28 illustrates a method 400 of relieving a hyperirritable area on or surrounding a mandible. Initial step 402 of method 400 may include selecting a first head component from a set of head components of a myofascial release apparatus (MRA). Another step 404 of method 400 may include connecting the first head component with a handle of the MRA. Another step 406 of method 400 may include locating the hyperirritable area on or surrounding the mandible of a patient experiencing muscle tension. Another step 408 of method 400 may include contacting the hyperirritable area, via a contact member of the first head component, on or surrounding the mandible of the patient. Another step 410 of method 400 may include actuating a motor of the MRA, via an electrical control assembly of the MRA, from an OFF state to an ON state for vibrating the first head component at at least one predetermined frequency. Another step 412 of method 400 may include relieving the hyperirritable area on or surrounding the mandible.

In an exemplary embodiment, method 400 may include additional steps of relieving a hyperirritable area on or surrounding a mandible. An optional step may further include that the step of relieving the hyperirritable area on or surrounding the mandible further includes that the hyperirritable area is a myofascial trigger point that is one of interior to an oral cavity of the patient and exterior to the oral cavity of the patient. Optional steps may further include actuating a head sensor switch of the electrical control assembly; sending at least one electrical signal to a primary controller of the electrical control assembly; and controlling the motor, via the primary controller, for vibrating the at least one head component at the at least one predetermined frequency. Optional steps may further include introducing the first head component into an oral cavity of the patient; and contacting an intraoral muscle, via the contact member, positioned inside of the oral cavity of the patient. An optional step may further include that the step of contacting the intraoral muscle positioned inside of the oral cavity of the patient includes the intraoral muscle being a lateral pterygoid muscle. An optional step may further include that the step of contacting the intraoral muscle positioned inside of the oral cavity of the patient includes the intraoral muscle being a medial pterygoid muscle. An optional step may further include that the step of contacting the intraoral muscle positioned inside of the oral cavity of the patient includes the intraoral muscle being proximate to a maxillary tuberosity. Optional steps may further include removing the first head component from the handle; selecting a second head component from the set of head components; connecting the second head component with the handle; actuating the motor, via the switch, from the OFF state to the ON state to vibrate the second head component at the predetermined frequency; locating a second hyperirritable area on or surrounding the patient experiencing muscle tension; contacting the second hyperirritable area, via a second contact member of the second head component, on or surrounding the mandible of the patient; and relieving the second hyperirritable area on or surrounding the mandible of the patient. An optional step may further include that the second contact member of the second head component defines a diameter that is greater than the contact member of the first head component. Optional steps may further include introducing the second head component into an oral cavity of the patient; and contacting an intraoral muscle, via the second contact member, positioned inside of the oral cavity of the patient. An optional step may further include that the step of contacting the intraoral muscle, positioned inside of the oral cavity of the patient further includes that the intraoral muscle is a masseter muscle. An optional step may further include that the step of contacting the intraoral muscle, positioned inside of the oral cavity of the patient further includes that the intraoral muscle is an orbicularis oris muscle. Optional steps may further include removing the second head component from the handle; selecting a third head component from the set of head components; connecting the third head component with the handle; actuating the motor, via the switch, from the OFF state to the ON state to vibrate the third head component at the predetermined frequency; locating a third hyperirritable area on or surrounding the mandible of the patient; contacting the third hyperirritable area, via a third contact member of the third head component, on or surrounding the mandible of the patient; and relieving the third hyperirritable area on or surrounding the mandible of the patient. An optional step may further include that the third contact member of the third head component defines a diameter that is greater than the second contact member of the second head component. Optional steps may further include introducing the third head component exterior to an oral cavity of the patient; and contacting an extraoral muscle, via the third contact member, positioned outside of the oral cavity of the patient. An optional step may further include that the step of contacting the extraoral muscle positioned outside of the oral cavity of the patient includes the extraoral muscle being a masseter muscle. An optional step may further include that the step of contacting the extraoral muscle positioned outside of the oral cavity of the patient includes the extraoral muscle being a temporalis muscle. An optional step may further include that the step of contacting the extraoral muscle positioned outside of the oral cavity of the patient includes the extraoral muscle being a sternocleidomastoideole. An optional step may further include that the step of contacting the extraoral muscle positioned outside of the oral cavity of the patient includes the extraoral muscle being an upper trapezius muscle. Optional steps may further include removing the third head component from the handle; selecting a fourth head component from the set of head components; connecting the fourth head component with the handle; actuating the motor, via the switch, from the OFF state to the ON state to vibrate the fourth head component at the predetermined frequency; locating a fourth hyperirritable area on or surrounding the mandible of the patient; contacting the fourth hyperirritable area, via a fourth contact member of the fourth head component, on or surrounding the mandible of the patient; and relieving the fourth hyperirritable area on or surrounding the mandible of the patient. An optional step may further include that the fourth contact member of the fourth head component defines a different shape than any one of the first, second, and third contact members of the first, second, and third head components. Optional steps may further include introducing the fourth head component exterior to an oral cavity of the patient; contacting an extraoral muscle with the fourth contact member that is positioned outside of the oral cavity of the patient; and scraping the extraoral muscle with the fourth contact member; wherein the extraoral muscle is one of a temporalis muscle, sternocleidomastoideole, an upper trapezius muscle, and a masseter muscle.

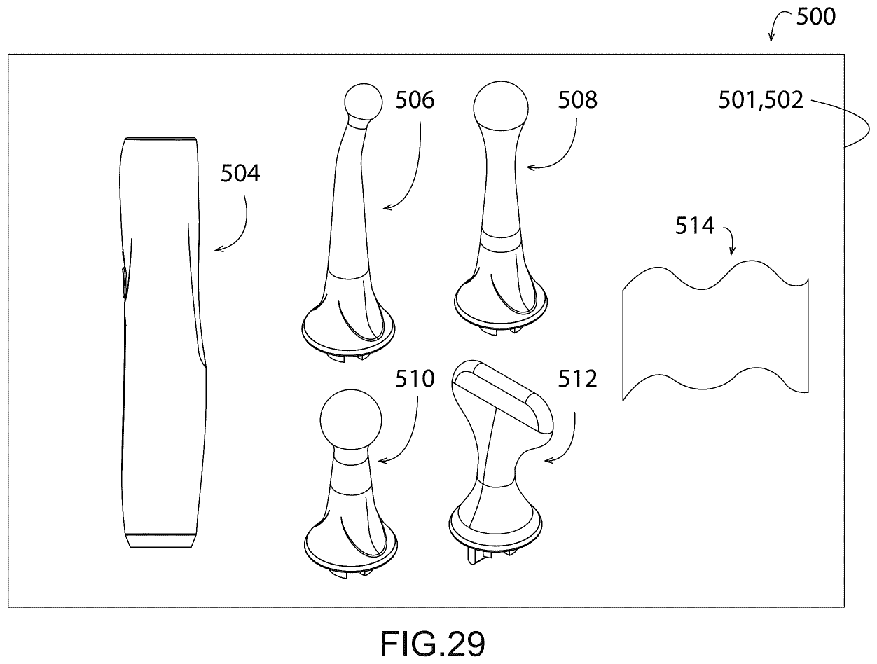

FIG. 29 illustrates an exemplary kit 500. The kit 500 may include a container or package 501 that houses components of a MRA 502. The MRA 502 may include a handle 504 and at least two head components 506, 508 that are interchangeable with the handle 504. The first head component 506 may be configured to relieve myofascial pain and dysfunction interior to an oral cavity, and the second head component 508 may be configured relieve myofascial pain and dysfunction exterior to an oral cavity. As such, the first head component 506 may be the head component 60 or the head component 160 due to each of the head components 60, 160 being used for intraoral treatment. The second head component 508 may be the head component 260 or the head component 360 due to each of the head components 260, 460 being used for extraoral treatment.

In the illustrated embodiment, the kit 500 may include the MRA 502. The MRA 502 may include a handle 504, a first head component 506, a second head component 508, a third head component 510, and a fourth head component 512. The handle 504 is identical to the handle 10 described and illustrated herein. Additionally, the first, second, third, and fourth head components 506, 508, 510, 512 are identical to the first, second, third, and fourth head components 60, 160, 260, 360 described and illustrated herein. The kit 500 may also include a manual 512 that describes how to uses and operate the MRA 502 for relieving and treating TMJ disorder.

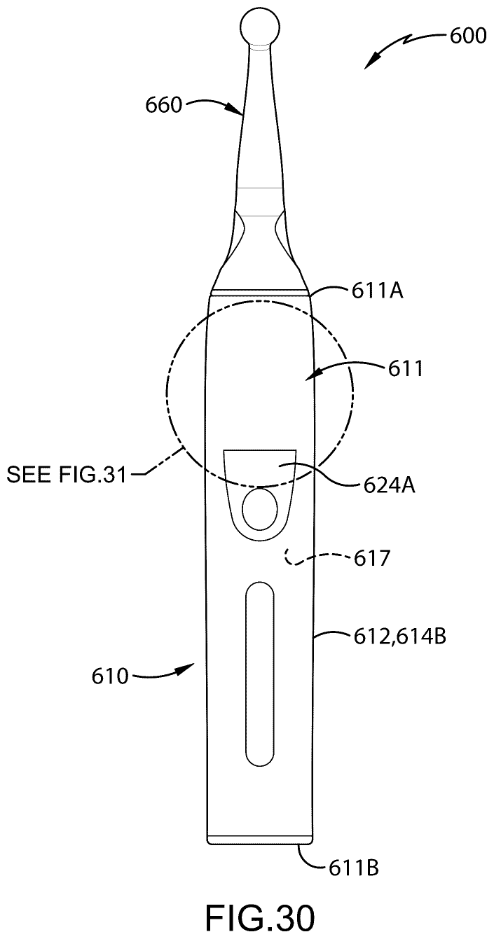

FIGS. 30-32B illustrate another MRA 600 that includes a handle, generally referred to as 610, configured to house various components and devices for generating vibrational energy along with at least one head component generally referred to as 660. The user of MRA 600 may select a desired head component (e.g., head component 660 or head components described herein) to relieve myofascial pain and dysfunction for patient located interior to an oral cavity and/or located exterior to an oral cavity of said patient.

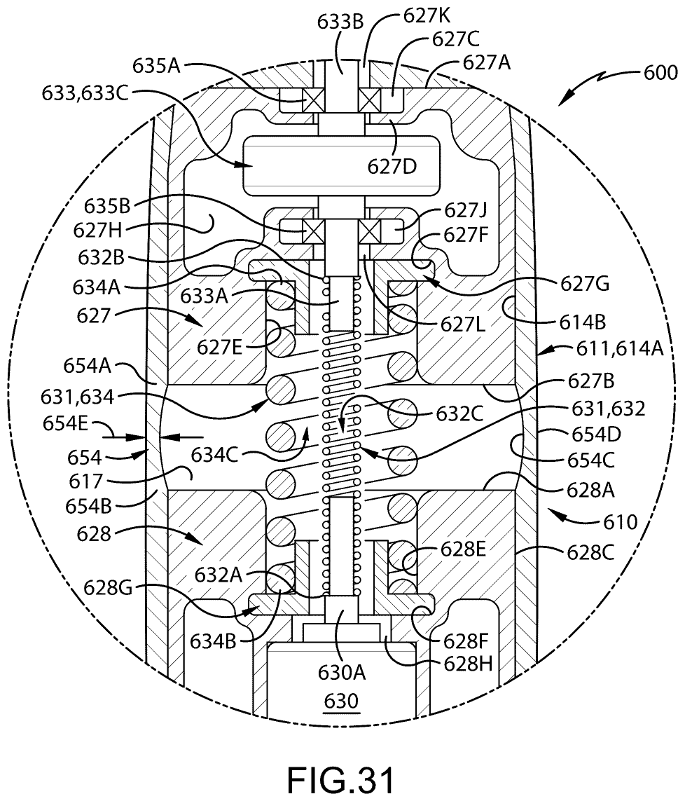

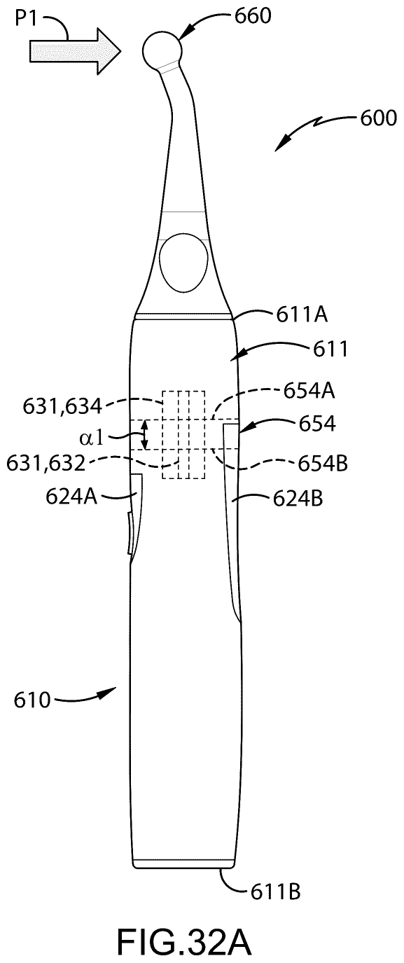

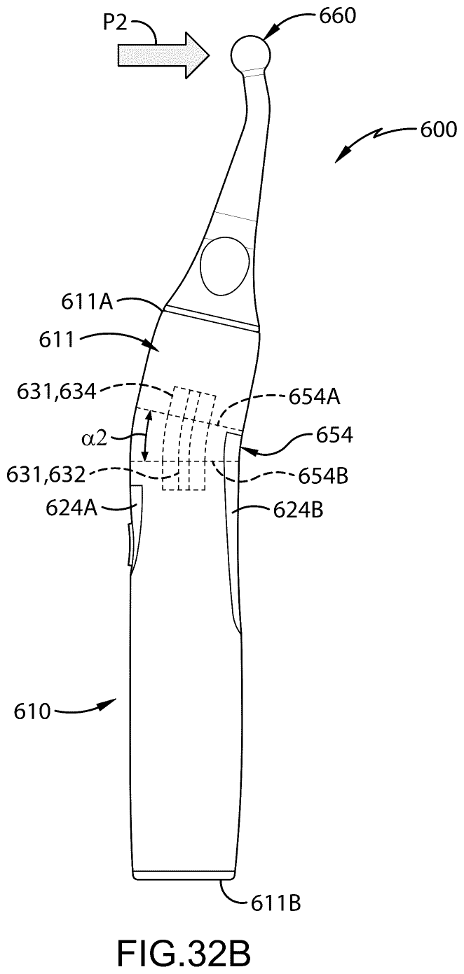

As illustrated in FIGS. 30 and 31, the handle 610 may include a case 611 configured to house various components and devices for generating vibrational energy. The case 611 includes a top end 611A, and bottom end 611B opposite to the top end 611A, and a longitudinal axis defined therebetween. The case 611 may include a circumferential wall 612 that extends between the top end 611A of the case 611 and the bottom end 611B of the case 611. The circumferential wall 612 may include an outer surface 614A that extends from the top end 611A of the case 611 to the bottom end 611B of the case 611. The circumferential wall 612 may also include an inner surface 614B that is opposite to the outer surface 614A and that extends from the top end 611A to the bottom end 611B of the case 611. The circumferential wall 612 also defines a chamber 617 between the top and bottom ends 611A, 611B of the case 611 (see FIG. 31). As illustrated in FIG. 32, the circumferential wall 612 may define a curve between the top and bottoms ends 611A, 611B of the case 611 similar to MRA 1 discussed above.

Additionally, with respect to the case 611, case 611 may include similar and/or identical components or elements of case 11 of handle 10 discussed above. While not illustrated herein, case 611 may include top and bottom surfaces (similar to top and bottom surfaces 18a, 18b of case 11) as well as defining a top opening (similar to top opening 20) in the top end 611a and a bottom opening (similar to bottom opening 22) in the bottom end 611b to provide access to the chamber 617.

Still referring to FIG. 30, the case 611 also defines a front indentation 624A in the circumferential wall 612. The front indentation 624A is defined between the top and bottom ends 611A, 611B of the case 611 proximate to the top end 11A of the case 11. As shown in FIG. 30, the front indentation 624A extends inwardly towards the chamber 617 and is adapted to receive a first digit of a user (e.g., an index finger of a user) when using the MRA 600. The case 611 also defines an opposing rear indentation 624B in the circumferential wall 612 (see FIG. 32A). The rear indentation 624B is defined between the top and bottom ends 611A, 611B of the case 11 proximate to the top end 611A of the case 611. As shown in FIG. 30 the rear indentation 624B extends inwardly towards the chamber 617 and is adapted to receive a second digit of a user (e.g., a thumb of a user) when using the MRA 600.

As best seen in FIGS. 32A-32B, the front and rear indentations 624A, 624B are aligned with one another relative to the longitudinal axis of the case 611. The locations of the front and rear indentations 624A, 624B allow a user to apply a pinching or squeezing force with first and second digits against the case 11 inside of the front and rear indentations 624A, 624B. In other words, the front and rear indentations 624A, 624B defined in the circumferential wall 612 of the case 611 provides the user with additional grip support when holding and using the MRA 600 during treatments. The user's remaining digits may grasp below the front and rear indentations 624A, 624B when using the MRA 600 during treatments. In the illustrated embodiment, the front and rear indentations 624A, 624B are curvilinear shaped, more particularly ovoidal, to match the shape of a user's digits. In other exemplary embodiments, first and second indentations of a handle may define any suitable shape or configuration to allow a user to grip a handle when using a MRA during a treatment.

Referring to FIG. 30, the case 611 may define a side opening 625 in the circumferential wall 612 where the outer and inner surfaces 614A, 614B are in fluid communication with one another via the side opening 625. The side opening 625 is defined between the top end 611A and the bottom end 611B proximate to the top end 611A. As seen in FIG. 30, the side opening 625 is aligned inside of the front indentation 624A. Similar to side opening 25, side opening 625 is configured to house a switch (such as switch 41A discussed herein) for controlling vibrational energy generated by a vibration motor of MRA 600 as well as an electrical control assembly and components connected to the electrical control assembly.

While not illustrated herein, case 611 may also include a pair of engagement members (such as engagement members 26A, 26B) that enables the head component 660 to interlockingly engage with the handle 610.

Handle 610 also includes a first or upper support 627 that operably engages with the case 611 inside the chamber 617. As best seen in FIG. 31, the upper support 627 operably engages with the inner surface 614B of the case 611 inside the chamber 617. In the illustrated embodiment, the case 611 and the upper support 627 may be separate component that operably engage with one another. In one exemplary embodiment, a case and an upper support described and illustrated herein may be a single, integral part such that the case and the upper support form a single, unitary member.

As best seen in FIG. 31, upper support 627 may include a top end 627A, a bottom end 627B opposite to the top end 627A, and a longitudinal axis defined therebetween. Upper support 627 may define a recess 627C that extends downwardly from the top end 627A to an intermediate wall 627D. Upper support 627 may also define a lower cavity 627E that extends upwardly into the upper support 627 from the bottom end 627B to an upper notch 627F; such use and purpose of upper notch 627F is discussed in greater detail below.

Upper support 627 may also include an upper coupler 627G. As best seen in FIG. 31, the upper coupler 627G is positioned inside of the lower cavity 627E and inside of upper notch 627F. Particularly, a first or base portion of the upper coupler 627G is housed inside of the upper notch 627F, and a second or extension portion of the upper coupler 627G is housed inside of the lower cavity 627E. It should also be noted that such upper coupler 627G is hollow and defines a passageway therethrough to receive one or more components of a drive assembly of MRA 600, which are discussed in greater detail below. As discussed in greater detail below, the upper coupler 627G is configured to engage with at least one component of drive assembly of MRA 600 or additional internal components. As described in more detail below, the upper support 627 provides structural support to various mechanical and electrical devices configured to generate vibrational energy for myofascial release of trigger points or hyperirritable areas.

While not illustrated herein, upper support 627 may also include a vibration transfer element or connection. Similar to vibration transfer element 27J, the vibration transfer element of this MRA 600 is configured to transfer vibrational energy from the handle 610 to the head component 660 when the head component 660 operably connects with the handle 610.

Upper support 627 may also define a first passageway 627L that extends longitudinal through the upper support 627 and may provide communication between the lower cavity 627E and the intermediate chamber 627H for transferring mechanical energy to the head component 660. In the present disclosure, the passageway 627L may also provide communication between the lower cavity 627E and the upper channel 627J and between the intermediate chamber 627H and the upper channel 627J so that components of a drive assembly of MRA 600 may pass through to transfer mechanical energy to the head component 660. Upper support 627 also defines a second passageway 627K to enable a shaft of a vibration weight of drive assembly of MRA 600 to extend through and to transfer vibrational energy to the head component 660.

Handle 610 may also include a second or lower support 628 that operably engages with the case 611 inside the chamber 617. More particularly, the lower support 628 operably engages with the inner surface 614B of the case 611 inside the chamber 617 and vertically opposite to the upper support 627. In the illustrated embodiment, the case 611 and the lower support 628 may be separate component that operably engage with one another. In one exemplary embodiment, a case and a lower support described and illustrated herein may be a single, integral part such that the case and the lower support form a single, unitary member.

As best seen in FIG. 31, lower support 628 includes a top end 628A, a bottom end (not shown) opposite to the top end 628A, and a longitudinal axis defined therebetween. Lower support 628 may also include a circumferential wall 628C that extends longitudinally between the top end 628A and the bottom end 628B. Lower support 628 also defines a top recess 628E that extends downwardly from the top end 628A of the lower support 28 to a lower notch 628F to engage with a lower coupler of lower support 628, which is discussed in greater detail below.

Lower support 628 may also include a lower coupler 628G. As best seen in FIG. 31, the lower coupler 628G is positioned inside of the recess 628E and inside of lower notch 628F. Particularly, a first or base portion of the lower coupler 628G is housed inside of the lower notch 628F, and a second or extension portion of the lower coupler 628G is housed inside of the recess 628E. It should also be noted that such lower coupler 628G is hollow and defines a passageway therethrough to receive one or more components of a drive assembly of MRA 600, which are discussed in greater detail below. As discussed in greater detail below, the lower coupler 628G is configured to engage with at least one component of drive assembly of MRA 600 or additional internal components. Still referring to lower support 628, lower support 628 also defines passageway 628H that extends through the base wall 628F and is in communication with the chamber 628D. As described in more detail below, the lower support 628 provides structural support to various mechanical and electrical devices configured to generate vibrational energy for myofascial release of trigger points or hyperirritable areas.

Still referring to FIG. 31, the handle 610 may include a vibration motor 630 operably engaged with the lower support 628. More particularly, vibration motor 630 is provided inside of and operably engages with the lower support 628 below the top recess 628E. As described in more detail below, the vibration motor 630 is configured to produce mechanical energy via rotational force to a drive assembly (described in more detail below) to enable the at least one head component 660 to provide a myofascial massage or manipulation to an applied area (either intraorally or extraorally).

Similar to vibration motor 630, the vibration motor 630 is configured to have variable speeds and/or intensities for generating vibrational energy to the head component 660. As such, the configuration and/or operation of the vibration motor 30 discussed herein may be applied equally to the configuration and/or operation of the vibration motor 630 of MRA 600.

Handle 610 may also include a drive assembly 631 that operably engaged with the vibration motor 630. In general, the drive assembly 631 is configured to transfer the mechanical energy produced by the vibration motor 630 to the head component 660, which is described in more detail below. During operation, the vibration motor 630 transmits the mechanical energy to the drive assembly 631 which is ultimately transmitted to the at least one head component 660. Such components and elements of drive assembly 631 are described in greater detail below.

Drive assembly 31 may include an inner connection or flexible shaft 632 that operably engages with a drive shaft 630A of the vibration motor 630. As best seen in FIG. 31, flexible shaft 632 is a spring-like shaft or deformable shaft that transfer the mechanical energy from the vibration motor 630 to the head component 660. In other exemplary embodiments, flexible shaft 632 may be any suitable component and/or element that may transfer the mechanical energy from the vibration motor 630 to the head component 660. Flexible shaft 632 includes a first or input end 632A that operably engages with the drive shaft 630A of vibration motor 630 inside of the top recess 628E of lower support portion 628. Flexible shaft 632 may also include a second end 632B that is opposite to the first end 632A and operably engages with a vibration weight of drive assembly 631 inside of the lower cavity 627E of upper support portion 627, which is described in more detail below. Flexible shaft 632 may also define a passageway 632C that extends between the first end 632A and the second end 632B where each of the first end 632A and the second end 32B is an open end to allow access into the passageway 632C. As such, the drive shaft 630A of vibration motor 630 and an axle or shaft of the vibration weight operably engages inside of the flexible shaft 632.

Drive assembly 631 may also include a vibration weight 633 that operably engages with the flexible shaft 632. As best seen in FIG. 31, vibration weight 633 may include a first or input shaft 633A that operably engages with the upper support 627 inside of the upper channel 627J. The first shaft 633A is also partially disposed inside of the recess 627C. Vibration weight 633 may also include a second or output shaft 633B that is opposite to the first shaft 633A and that operably engages with the flexible shaft 632. More particularly, the second shaft 633B operably engages with the output end 632B of the flexible shaft 632 where the second shaft 633B is positioned inside of the passageway 632C defined in the flexible shaft 632. While the first shaft 633A and the second shaft 633B may be separate components in vibration weight 633, first and second shafts in a vibration weight described herein may collectively define a single shaft for a vibration weight described herein,

Vibration weight 633 may also include an offset or eccentric mass 633C that operably engages with the first shaft 633A and the second shaft 633B. As best seen in FIG. 31, offset mass 633C may be positioned between the first shaft 633A and the second shaft 633B while being offset from the first shaft 633A and the second shaft 633B to create a counterbalance. Such use of offset mass 633C is considered advantageous at least because the offset mass 633C generates vibrational energy inside of the case 611 upon receiving mechanical energy (i.e. rotational force) from flexible shaft 632 that was originally generated by the vibration motor 630. As described in more detail below, the vibrational energy generated by the vibration weight 633 is then transferred to the head component 660 for treating trigger points or hyperirritable areas experienced by a patient.

Drive assembly 631 may include an outer connection or biaser 634 that operably engages with the upper support 627 and the lower support 628. In the illustrated embodiment, biaser 634 is a spring that transfer the mechanical energy from the lower support 628 to the upper support 627. In other exemplary embodiments, biaser 634 may be any suitable component and/or element that may transfers the mechanical energy from the lower support 628 to the upper support 627. Biaser 634 includes a first end 634A that operably engages with the upper support 627, particularly the upper coupler 627G, inside of the lower cavity 627E. Biaser 634 may also include a second end 634B that is opposite to the first end 634A and operably engages with the lower support 628, particularly the lower coupler 628G, inside of the top recess 628E. Biaser 634 may also define a passageway 634C that extends between the first end 634A and the second end 634B where each of the first end 634A and the second end 634B is an open end to allow access into the passageway 634C. The passageway 634C is also configured to receive and house the drive shaft 630A of vibration motor 630, a portion of the flexible shaft 632, and first shaft 633A of vibration weight 633 upon assembly of handle 610. As discussed in greater detail below, biaser 634 is configured to bias the case 611 to a first or relaxed configuration after an exertion of pressure is asserted against the case 611 that bends the case 611 and reduces vibrational energy to the head component 660 to prevent harm or damage to a patient by the MRA 600.

Drive assembly 631 may also include at least one roller bearing that operably engages with one or both of the first shaft 633A and the second shaft 633B of vibration weight for providing rotational and/or axial support to one or both of the first shaft 633A and the second shaft 633B. As best seen in FIG. 31, drive assembly 631 includes an upper roller bearing 635A that operably engages with the first shaft 633A of vibration weight 633. Upper roller bearing 635A also operably engages with the upper support 627 inside of the recess 627C. As such, upper roller bearing 635A provides rotational and/or axial support to the second shaft 633B. Drive assembly 631 includes a lower roller bearing 635B that operably engages with the second shaft 633B of vibration weight 633. Lower roller bearing 635B also operably engages with the upper support 627 inside of the upper channel 627J. As such, lower roller bearing 635B provides rotational and/or axial support to the first shaft 633A.

While not illustrated herein, MRA 600 may include first and second isolators (such as first isolator 36A and the second isolator 36B of MRA 1) that are positioned radially about the upper roller bearing 635A and the lower roller bearing 635B in one exemplary embodiment. In this exemplary embodiment, the first and second isolators may be made from soft and resilient material to isolate the vibrational energy towards the transfer element 627K and absorb said vibrational energy away from the circumferential wall 612. In other words, the first and second isolators may be configured to direct unwanted vibrational energy away from the case 611 and towards the head component 660 for providing a suitable massaging to a patient's trigger point.

In this embodiment, MRA 600 also includes an electrical control assembly (not illustrated herein) that controls the vibration motor 30 and other electrical components for generating vibrational energy to alleviate and/or massage a patient's trigger point. As such, the electrical control assembly 38 of MRA 1 discussed herein may apply substantially similar to the electrical control assembly of MRA 600.

Referring to FIG. 31, the case 611 of handle 610 also includes a deformable wall portion 654. In the present disclosure, deformable wall portion 654 includes a first end 654A that operable engages with the bottom end 627B of the upper support portion 627. Deformable wall portion 654 also includes a second end 654b vertically opposite to the first end 654A and operable engages with the top end 628A of the lower support portion 628. Deformable wall portion 654 also includes an internal surface 654C that faces into the chamber 617 and extends vertically between the first end 654A and the second end 654B. In the present disclosure, internal surface 654C defines a curvilinear shape between the first and second ends 654A, 54B to assist the case 611 in bending and/or deforming when a predetermined pressure is applied during use. Deformable wall portion 654 also includes an exterior surface 654D that is in communication with the environment surrounding the handle 610 and extends vertically between the first end 654A and the second end 654B. Deformable wall portion 654 also defines a thickness 654E between the internal and exterior surfaces 654D, 654E. As best seen in FIG. 31, the thickness 654E tapers inwardly from the first end 654A to a medial point of the deformable wall portion 654 and tapers inwardly from the second end 654B to the medial point of the deformable wall portion 654; such varied thickness enables the handle 610 to bend and/or flex at such deformable wall portion 654, which is discussed in greater detail below.

In operation, the deformable wall portion 654 bends and/or flexes the case 611 between the upper support portion 627 and the lower support portion 628 when the pressure applied to the MRA 600 meets a predetermined pressure threshold of said deformable wall portion 654. Stated differently, the deformable wall portion 654 bends and/or deforms when the user or patient exerts a predetermined amount of force onto head component 660 of the MRA 600 that is greater than a bending stress or strength of the deformable wall portion 654 to prevent harmful, and potentially damaging, pressure applied to the user's or patient's myofascial point by said MRA 600. In one instance, the deformable wall portion 654 remains at a first or relaxed configuration (see FIG. 32A) when the pressure applied to the head component of the MRA 600 is less than the bending strength of the deformable wall portion 654. In this instance, a top surface of case 611 located along the top end 611A of case 611 and a bottom surface of case 611 located along bottom end 611B of case 611 are aligned with one another relative to the longitudinal axis of the case 611. In another instance, the deformable wall portion 54 translates to a second or flexed configuration when the pressure applied to the head component of the MRA 600 is greater than the bending strength of the deformable wall portion 654. In this instance, a top surface located along the top end 611A of case 611 and a bottom surface located along the bottom end 611B of case 611 are offset from one another relative to the longitudinal axis of the case 611. In the flexed configuration, the flexible shaft 632 may bend resulting in a reduction of energy or mechanical power between the vibration weight 633 and the vibration motor 630 to prevent harmful or unwanted pressure at the patient's myofascial point.

Such deformable wall portion 654 is considered advantageous at least because such deformation of the case 611 prevents harmful or damaging pressure applied to a patient's myofascial point or affected area. In one instance, when the deformation wall portion 654 is maintained at the first or relaxed configuration, the drive assembly 631 transfers complete vibrational energy or a first amount of vibrational energy from the vibration motor 630 to the vibration weight 633. In another instance, when the deformation wall portion 654 is bent and/or deformed to the second or flexed configuration, the drive assembly 631 transfers a reduced amount of vibrational energy or a second amount of vibrational energy from the vibration motor 630 to the vibration weight 633 that is less than the first amount of vibration energy. With such deformable wall portion 654, users or patients that operate MRA 600 have a built-in safety mechanism to prevent further damage or harm when using one or more types of head components for relieving one or more myofascial points or affected areas.

As illustrated in FIG. 30, head component 660 operably engages with the handle 610, particularly the case 611 and the upper support 627. The head component 660 may be removable from the case 611 and the upper support 627 for various reasons, including changing to another head component described herein for different treatment to the patient. The head component 660 is also configured to relieve myofascial pain and dysfunction interior to an oral cavity including the temporomandibular joint, the lateral pterygoid muscle, and the medial pterygoid muscle, which is described in more detail below. In this illustrated embodiment, the head component 660 is primarily used as an intraoral head component 660 for providing ischemic compression treatment at specific trigger points or hyperirritable areas interior to the patient's oral cavity. In addition, however, the head component 60 may be configured to relieve myofascial pain and dysfunction exterior to an oral cavity including a patient's temporalis muscle, a patient's lateral pterygoid muscle, a patient's medial pterygoid muscle, a patient's masseter muscle, a patient's sternocleidomastoideole, and a patient's trapezius muscle, which is described in more detail below.

It should be understood that other additional head components mentioned herein may be equipped to handle 610 to relieve myofascial pain and dysfunction interior to an oral cavity or exterior to an oral cavity. Examples of suitable head components that may be equipped to handle 610 to relieve myofascial pain and dysfunction interior to an oral cavity or exterior to an oral cavity include head component 60, head component 160, head component 260, and head component 360.

FIGS. 32A and 32B illustrate operational views of the MRA 600 translating between the relaxed configuration and the flexed configuration when different types of pressures are applied to the MRA 600 by a user or patient.

With respect to FIG. 32A, a first pressure or force (denoted as an arrow labeled P1 in FIG. 32A) is applied to the MRA 600 by a user or patient to relieve specific trigger points or hyperirritable areas interior or exterior to the patient's oral cavity. In this instance, the first pressure is less than the predetermined pressure threshold or bending stress of the deformable wall portion 654 thus maintaining case 611 at the relaxed configuration. In this instance, a first angle of deformation is defined between the first end 654A of the deformation wall portion 654 and the second end 654B of the deformation wall portion 654; such first angle of deformation is denoted by arrows labeled “α1” in FIG. 32A. In this instance, the first and second end 654A, 654B of the deformation wall portion 654 are parallel to one another relative to a longitudinal axis of the deformable wall portion 654 that extends between the first and second ends 654A, 654B. It should be noted that in other exemplary embodiments, the first and second end 654A, 654B of the deformation wall portion 654 may be substantially parallel to one another in that the first and second ends 654A, 654B may be at least one degree offset to one another but still be maintained in the relaxed configuration.

As noted above, the driving assembly 631 is configured to transfer complete mechanical energy from the vibration motor 630 to the head component 660 in the relaxed configuration. In this configuration, the flexible shaft 632 is substantially linear between the first end 632A and the second end 632B in which the first and second end 632A, 632B are aligned with one another (see FIG. 32A). With such linear shape, the flexible shaft 632 is free from being hindered to transfer the mechanical energy along a linear axis. Additionally, the biaser 634 biases and/or maintains the case 611, and the deformation wall portion 654, at the relaxed configuration since the first pressure P1 is less than a biasing force applied by the biaser 634 to the case 611.

With respect to FIG. 32B, a second pressure or force (denoted as an arrow labeled P2 in FIG. 32B) is applied to the MRA 600 by a user or patient to relieve specific trigger points or hyperirritable areas interior or exterior to the patient's oral cavity. In this instance, the second pressure is greater than the predetermined pressure threshold or bending stress of the deformable wall portion 654 thus bending the case 611 from the relaxed configuration to the flexed configuration. In this instance, a second angle of deformation is defined between the first end 654A of the deformation wall portion 654 and the second end 654B of the deformation wall portion 654; such second angle of deformation is denoted by arrows labeled “α2” in FIG. 32B. In this instance, the second angle α2 is different from the first angle α1 in which the first and second ends 654A, 654B are offset and/or non-linear to one another relative to a longitudinal axis of the deformable wall portion 654 that extends between the first and second ends 654A, 654B.

As noted above, the driving assembly 631 is configured to transfer complete mechanical energy from the vibration motor 630 to the head component 660 in the relaxed configuration. In this configuration, however, the flexible shaft 632 is bent and/or flexed to a non-linear shape between the first end 632A and the second end 632B in which the first and second end 632A, 632B are offset to one another (see FIG. 32B). With such non-linear shape, the flexible shaft 632 is hindered to transfer the complete amount of mechanical energy from the vibration motor 630 to the head component 660 thus preventing harmful and/or damaging pressure onto a hypersensitive point being treated by the MRA 600. Additionally, the second pressure P2 also causes the biaser 634 to flex with the deformable wall portion 654 due to the second pressure P2 being greater than the biasing force applied by the biaser 634.

Once the pressure P2 is removed, the biaser 634 then biases and/or the case 611 and the deformation wall portion 654, from the flexed configuration to the relaxed configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A myofascial release apparatus (MRA), comprising:
a handle deformable between a relaxed configuration and a flexed configuration at a location between a top end and a bottom end;
a motor operably engaged with the handle and configured to generate a mechanical energy;
a drive assembly operably engaged with the motor and the handle and configured to generate a vibrational energy;
an electrical control assembly electrically connected with the motor for controlling said motor; and
at least one head component operably connected with the handle and the drive assembly; wherein the at least one head component is removable from the handle and the motor, and wherein the at least one head component is configured to relieve at least one hyperirritable area via the vibrational energy.

2. The apparatus of claim 1, wherein when the handle is in the relaxed configuration, the drive assembly transfers the vibrational energy completely to the at least one head component; and
wherein when the handle is in the flexed configuration, the drive assembly is free from transferring the vibrational energy to the at least one head component.

3. The apparatus of claim 1, wherein when the handle is in the flexed configuration, a predetermined amount of force is applied to the handle to reduce the vibrational energy transferred by an input drive of the drive assembly.

4. The apparatus of claim 1, wherein the handle comprises:
a deformable wall portion defined at a location between the top end of the handle and the bottom end of the handle and configured to flex between the relaxed configuration and the flexed configuration.

5. The apparatus of claim 2, wherein the deformable wall portion comprises:
a wall thickness defined between an internal surface that is continuous with an interior surface of the handle and an external surface that is continuous with an exterior surface of the handle;
wherein the wall thickness is less than a handle thickness of the handle defined between the top end and the deformable wall portion and defined between the bottom end and the deformable wall portion.

6. The apparatus of claim 3, wherein the internal surface of the deformable wall portion defines a curvilinear shape.

7. The apparatus of claim 2, wherein the deformable wall portion further comprises:
a first end operably engaging with an upper support that extends from the top end of the handle to the deformation wall portion; and
a second end operably engaging with a lower support extending from the bottom end of the handle to the deformation wall portion.

8. The apparatus of claim 7, wherein the first end and the second end are parallel to one another when the deformation wall portion in the relaxed configuration.

9. The apparatus of claim 7, wherein the first end and the second end are substantially offset to one another when the deformation wall portion in the flexed configuration.

10. The apparatus of claim 7, wherein the drive assembly comprises:
a flexible shaft operably engaged with the motor; and
a vibration weight operably engaged with a vibration transfer element and the flexible shaft for generating the vibrational energy.

11. The apparatus of claim 10, wherein when the deformation wall portion is in the relaxed configuration, the flexible shaft is configured to transfer a first amount of vibrational energy to the at least one head component,
wherein when the deformation wall portion is in the flexed configuration, the drive assembly transfers a second amount of vibrational energy to the at least one head component, wherein the second amount of vibrational energy is less than the first amount of vibrational energy.

12. The apparatus of claim 10, wherein when the deformation wall portion is in the relaxed configuration, the flexible shaft transfers the vibrational energy completely to the at least one head component; and
wherein when the deformation wall portion is in the flexed configuration, the flexible shaft is free from transferring the vibrational energy to the at least one head component

13. The apparatus of claim 10, further comprising:
at least one biaser operably engaging the upper support and the lower support with one another and encapsulating the flexible shaft;
wherein the at least one biaser is configured to bias the deformation wall portion to the relaxed configuration.

14. The apparatus of claim 13, further comprising:
a first end of the at least one biaser operably engaging with the upper support inside of an upper support cavity; and
a second end of the at least one biaser opposite to the first end and operably engaging with the lower support inside of a lower support cavity.

15. The apparatus of claim 8, wherein the drive assembly further comprises:
an upper roller bearing operably engaged with the vibration weight and the vibration transfer element; and
a lower roller bearing operably engaged with the vibration weight and the vibration transfer element.

16. The apparatus of claim 1, wherein the at least one head component is configured to relieve the at least one hyperirritable area via the vibrational energy in one of interior to an oral cavity and exterior to the oral cavity.

17. A method of relieving a hyperirritable area on or surrounding a mandible, comprising steps of:
connecting a head component with a handle of the MRA;
contacting the hyperirritable area, via a contact member of the at least one head component, on or surrounding the mandible of the patient;
generating vibrational energy at a predetermined frequency, via a motor of the MRA;
transferring the vibrational energy from the motor to the at least one head component;
reducing the vibrational energy when a predetermined pressure is exerted on the handle by the patient; and
relieving the hyperirritable area on or surrounding the mandible

18. The method of claim 17, wherein the step of reducing the vibrational energy further comprises:
bending the handle, via a deformation wall portion of the handle, from a relaxed configuration to a flexed configuration.

19. The method of claim 17, wherein a first end of the deformation wall portion and the second end of the deformation wall portion are parallel to one another when the deformation wall portion in the relaxed configuration; and
wherein the first end of the deformation wall portion and the second end of the deformation wall portion are substantially offset to one another when the deformation wall portion in the flexed configuration.

20. The method of claim 18, further comprising:
bending a flexible shaft of the driving assembly, wherein the flexible shaft operably engages with the motor and a vibration weight.
